(19) United States
(12) Patent Application Publication
(10) Pub. No.: US 2026/0265534 A1
(43) Pub. Date: Sep. 10, 2026

(54) VOLTAGE-DRIVEN CYCLIC MODULATION OF POLARIZATION ROTATION BY ION INTERCALATION

(71) Applicant: The Regents of the University of Michigan, Ann Arbor, MI (US)

(72) Inventor: Nicholas A. KOTOV, Ypsilanti, MI (US)

(73) Assignee: The Regents of the University of Michigan, Ann Arbor, MI (US)

(21) Appl. No.: 19/167,231

(22) PCT Filed: Mar. 20, 2024
(86) PCT No.: PCT/US2024/020700

§ 371 Date: Sep. 19, 2025

Related U.S. Application Data
(60) Provisional application No. 63/453,329, filed on Mar. 20, 2023.

(51) Int. Cl. C09C 3/08; B82Y 20/00; C08K 3/04; C08K 7/06; C08K 9/04; G02F 1/01; G02F 1/166

(52) U.S. Cl. CPC C09C 3/08; C08K 3/041; C08K 7/06; C08K 9/04; G02F 1/0136; G02F 1/166; B82Y 20/00; C01P 2002/72; C01P 2002/77; C01P 2002/82; C01P 2002/84; C01P 2002/85; C01P 2004/04; C01P 2004/64; C01P 2006/40; C01P 2006/60; C08K 2201/001; C08K 2201/011; G02F 2202/02; G02F 2202/36

(57) ABSTRACT

A nanoparticle exhibiting reversible chiroptical activity is provided that includes an electrically conductive metal oxide (where a metal selected from the group consisting of: vanadium, cobalt, iron, manganese, and combinations thereof) that has an intercalatable lattice structure. At least one organic chiral ligand is attached to a surface of the electrically conductive metal oxide. The nanoparticle exhibits a first chiroptical state having a first chirality when an ion is intercalated into the intercalatable lattice structure of the electrically conductive metal oxide and the nanoparticle exhibits a distinct second chiroptical state when the ion is absent from the intercalatable lattice structure. An electric force field applied to the nanoparticle modulates chiroptical activity. Nanocomposites incorporating such nanoparticles and devices incorporating such nanoparticles in optical components are also contemplated.

### CROSS-REFERENCE TO RELATED APPLICATIONS

This application claims the benefit of U.S. Provisional Application No. 63/453,329 filed Mar. 20, 2023. The entire disclosure of the above application is incorporated herein by reference.

### GOVERNMENT SUPPORT

This invention was made with government support under N00014-18-1-2876 awarded by the U.S. Office of Naval Research. The government has certain rights in the invention.

### FIELD

The present disclosure relates to nanoparticles that exhibit reversible chiroptical activity by having a lattice structure for intercalating an ion, where the nanoparticles are responsive to an electric force field to modulate ion movement and thus chiroptical activity. Nanocomposites incorporating such nanoparticles and devices including optical components with such nanoparticles are also contemplated.

### BACKGROUND

This section provides background information related to the present disclosure which is not necessarily prior art.

Select materials with microscale and/or nanoscale chirality are known to rotate the polarization of linearly polarized (LinP) and circularly polarized light (CPL) strongly. Chirality of a microparticle or nanoparticle means that the structure exhibits asymmetrical optical activity with different handedness, for example, clockwise to form left handed chirality (S- or L-orientation) and counter-clockwise to form right handed chirality (R- or D-orientation). Such optical effects with different chiral geometries are being actively investigated as a part of chiral photonics and plasmonics for machine vision and the like.

Chiral ceramic nanostructures with high chiroptical activity provide attractive alternatives to noble metals and Group II-VI semiconductors. Furthermore, they can potentially provide new capabilities for real-time broad-band modulation of chiroptical activity, representing a key milestone for solid-state thin film chiroptical devices, among other applications. Thus, developing chiral nanoparticles having chiroptical properties that may be modulated by external force fields, such as an electric field, providing real-time precise modulation of chirality, would be desirable.

### SUMMARY

This section provides a general summary of the disclosure and is not a comprehensive disclosure of its full scope or all of its features.

In certain aspects the present disclosure relates to a nanoparticle exhibiting reversible chiroptical activity.

In one aspect, the nanoparticle may include an electrically conductive metal oxide having an intercalatable lattice structure and including a metal selected from the group consisting of: vanadium (V), cobalt (Co), iron (Fe), manganese (Mn), and combinations thereof. The nanoparticle may also include at least one organic chiral ligand attached to a surface of the electrically conductive metal oxide. The nanoparticle may exhibit a first chiroptical state having a first chirality when an ion is intercalated into the intercalatable lattice structure of the electrically conductive metal oxide. The nanoparticle may exhibit a distinct second chiroptical state when the ion is absent from the intercalatable lattice structure. The nanoparticle may be configured to have modulated chiroptical activity when an electric force field is applied.

In one aspect, the electrically conductive metal oxide may be selected from the group consisting of: vanadium (III) oxide (V₂O₃), cobalt (II, III) oxide (Co₃O₄), iron (III) oxide (Fe₂O₃), manganese dioxide (MnO₂), and combinations thereof.

In one aspect, the at least one organic chiral ligand may include at least one carboxylic group.

In one aspect, the at least one organic chiral ligand may be selected from the group consisting of: tartaric acid, malic acid, penicillamine, and combinations thereof.

In one aspect, the nanoparticle may have an average diameter of greater than or equal to about 0.5 nanometers to less than or equal to about 25 nanometers.

In one aspect, the nanoparticle may have an average diameter of greater than or equal to about 1 nanometer to less than or equal to about 5 nanometers.

In one aspect, the ion may be a zinc ion (Zn²⁺).

In one aspect, the electrically conductive metal oxide may include vanadium (III) oxide (V₂O₃), the at least one organic chiral ligand may include tartaric acid, and the ion may be a zinc ion (Zn²⁺).

In certain aspects the present disclosure also relates to a nanocomposite including at least one polymer and a plurality of nanoparticles exhibiting reversible chiroptical activity. For example, the plurality of nanoparticles may exhibit a reversible chiroptical activity that is configured to be modulated by an electric force field.

In one aspect, each respective nanoparticle may include an electrically conductive metal oxide having an intercalatable lattice structure and including a metal selected from the group consisting of: vanadium (V), cobalt (Co), iron (Fe), manganese (Mn), and combinations thereof and at least one organic chiral ligand attached to a surface of the electrically conductive metal oxide. Each nanoparticle may exhibit a first chiroptical state having a first chirality when an ion is intercalated into the intercalatable lattice structure of the electrically conductive metal oxide. Each nanoparticle may exhibit a distinct second chiroptical state when the ion is absent from the intercalatable lattice structure. The nanoparticles may be configured to have modulated chiroptical activity when an electric force field is applied.

In one aspect, the at least one polymer may be selected from the group consisting of: poly(dimethyldiallylammonium chloride) (PDDA), poly(acrylic acid) (PAA), polyvinyl alcohol (PVA), and combinations thereof.

In one aspect, the nanocomposite may further include an electrically conductive particle selected from the group consisting of: carbon nanotubes, metal nanowires, graphene oxide, graphene, and combinations thereof.

In one aspect, the electrically conductive particle may be selected from the group consisting of: carbon nanotubes, silver nanowires, and combinations thereof.

In one aspect, the electrically conductive metal oxide may be selected from the group consisting of: vanadium (III) oxide (V₂O₃), cobalt (II, III) oxide (Co₃O₄), iron (III) oxide (Fe₂O₃), manganese dioxide (MnO₂), and combinations thereof.

In one aspect, the nanocomposite may define a multilayered structure. A first layer of the multilayered structure may include poly(dimethyldiallylammonium chloride) (PDDA). A second layer of the multilayered structure may include poly(acrylic acid) (PAA) and the plurality of nanoparticles.

In one aspect, the second layer may further include an electrically conductive particle.

In one aspect, the at least one organic chiral ligand may be selected from the group consisting of: tartaric acid, malic acid, penicillamine, and combinations thereof.

In one aspect, the plurality of nanoparticles may have an average diameter of greater than or equal to about 1 nanometer to less than or equal to about 5 nanometers.

In one aspect, the nanocomposite may exhibit an electrical conductivity of greater than or equal to about 1.5×10³ S/cm.

In one aspect, the nanocomposite may define a plurality of pores and may further include at least one electrolyte disposed in at least a portion of the plurality of pores. The at least one electrolyte may include a zinc salt.

In certain aspects, the present disclosure also relates to a device that includes an optic component including a plurality of nanoparticles exhibiting reversible chiroptical activity.

In one aspect, each respective nanoparticle may include an electrically conductive metal oxide having an intercalatable lattice structure and including a metal selected from the group consisting of: vanadium (V), cobalt (Co), iron (Fe), manganese (Mn), and combinations thereof. Each respective nanoparticle may also include at least one organic chiral ligand attached to a surface of the electrically conductive metal oxide. Each nanoparticle may exhibit a first chiroptical state having a first chirality when an ion is intercalated into the intercalatable lattice structure of the electrically conductive metal oxide. Each nanoparticle may exhibit a distinct second chiroptical state when the ion is absent from the intercalatable lattice structure. An electric force field applied to the plurality of nanoparticles may modulate chiroptical activity. The device may also include an electric component for selectively generating an electric force field directed towards the optic component to drive the ion into the intercalatable lattice structure of the electrically conductive metal oxide of the plurality of nanoparticles, where the electric force field is configured to modulate chirality of an output of electromagnetic waves from the optic component.

In one aspect, the device may further include a source of light that directs electromagnetic waves towards the optic component.

In one aspect, the optic component may be a nanocomposite including the plurality of nanoparticles and also further including at least one polymer.

In one aspect, the at least one polymer may be selected from the group consisting of: poly(dimethyldiallylammonium chloride) (PDDA), poly(acrylic acid) (PAA), polyvinyl alcohol (PVA), and combinations thereof.

In one aspect, the nanocomposite may further include an electrically conductive particle selected from the group consisting of: carbon nanotubes, metal nanowires, graphene oxide, graphene, and combinations thereof.

In one aspect, the electrically conductive particle may be selected from the group consisting of: carbon nanotubes, silver nanowires, and combinations thereof.

In one aspect, the nanocomposite may define a multilayered structure. A first layer of the multilayered structure may include poly(dimethyldiallylammonium chloride) (PDDA). A second layer of the multilayered structure may include poly(acrylic acid) (PAA) and the plurality of nanoparticles. The second layer may also further include an electrically conductive particle.

In one aspect, the nanocomposite may define a plurality of pores and may further include at least one electrolyte disposed in at least a portion of the plurality of pores. The at least one electrolyte may include a zinc salt.

In one aspect, the electrically conductive metal oxide may be selected from the group consisting of: vanadium (III) oxide (V₂O₃), cobalt (II, III) oxide (Co₃O₄), iron (III) oxide (Fe₂O₃), manganese dioxide (MnO₂), and combinations thereof.

In one aspect, the at least one organic chiral ligand may be selected from the group consisting of: tartaric acid, malic acid, penicillamine, and combinations thereof.

In one aspect, the plurality of nanoparticles may have an average diameter of greater than or equal to about 1 nanometer to less than or equal to about 5 nanometers.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIGS. 1A-1J show various properties of chiral vanadium (III) oxide (V₂O₃) nanoparticles prepared in accordance with certain aspects of the present disclosure. FIGS. 1A and 1B show HRTEM images, FIG. 1C shows STEM with a 2 nanometers scale bar. FIG. 1D shows size distributions of nanoparticles. FIG. 1E shows STEM with a 5 nanometers scale bar. FIG. 1F shows high resolution atomic mapping of the L-NPs (pH=11) with a 5 nanometers scale bar. FIG. 1G shows vanadium 2p region XPS spectra of L, rac-NPs (pH=3, 7, 11). FIG. 1H shows XRD. FIG. 1I shows FTIR.

FIG. 1J shows Raman spectra of V₂O₃ NPs (pH=3, 7, 11).

FIGS. 2A-2K show various properties of solutions having chiral vanadium (III) oxide (V₂O₃) nanoparticles (NPs) prepared in accordance with certain aspects of the present disclosure. FIGS. 2A and 2B are photographs of the series of NPs solutions made with L- and D-TA NPs from pH 2 to 12, respectively. FIGS. 2C-2D show circular dichroism (CD) for the L- and D-TA NPs. FIGS. 2E and 2F show UV-vis-NIR absorbance of L- and D-NPs (pH 3-11). FIGS. 2G and 2H show photographs of light transmitted through dispersions of L- and D-V₂O₃ NPs with pH 11, fixed polarizer 1 and clockwise (G correspond to L-TA-NPs) and counterclockwise (H correspond to D-TA-NPs) rotation of polarizer 2 (each color changed with rotation approximately 3 degrees). FIGS. 2I-2K show dihedral angle for (FIG. 2I) L-, (FIG. 2J) ligand-free, and (FIG. 2K) D-NPs.

FIGS. 3A-3K show various properties of solutions and films having chiral vanadium (III) oxide (V₂O₃) nanoparticles prepared in accordance with certain aspects of the present disclosure. FIG. 3A shows CD and FIG. 3B shows absorbance of L- and D-NPs solution (in H₂O, solid line) and L-NP film (on ITO-glass, dashed line). FIGS. 3C-3E show photographs of light transmitting through (FIG. 3C) original status, (FIG. 3D) zinc intercalation, (FIG. 3E) zinc deintercalation of the L-NPs film. FIGS. 3F and 3G show CD and FIGS. 3H and 31 show absorbance of L- and D-V₂O₃/Ag NWs films. FIGS. 3J and 3K show reversible cycling performance of the films (CD intensity of films at 852 nanometers with zinc ions intercalation and deintercalation).

FIG. 4 shows a set-up of in-situ circular dichroism (CD) test.

FIG. 5 shows a table with comparison of g-factor with chiral nanoparticles and assemblies, including an inventive example having chiral vanadium (III) oxide (V₂O₃) nanoparticles prepared in accordance with certain aspects of the present disclosure. The references designated in the final column are as follows with the relevant portions incorporated herein by reference: 3. Gautier, C., et al., “Chiral inversion of gold nanoparticles,” Journal of the American Chemical Society 2008, 130 (22), 7077-7084; 4. Rodríguez-Zamora, P., et al., “Effect of the Metal-Ligand Interface on the Chiroptical Activity of Cysteine-Protected Nanoparticles,” Small 2021, 2004288; 5. Tohgha, U., et al., “Ligand induced circular dichroism and circularly polarized luminescence in CdSe quantum dots,” ACS nano 2013, 7 (12), 11094-11102; 6. Moloney, M., et al., “Chiral highly luminescent CdS quantum dots,” Chemical Communications 2007, (38), 3900-3902; 7. Yeom, J., et al., “Chiromagnetic nanoparticles and gels,” Science 2018, 359 (6373), 309-314; 8. Jiang, S., et al., “Chiral ceramic nanoparticles and peptide catalysis,” Journal of the American Chemical Society 2017, 139 (39), 13701-13712; 9. Li, Y., et al., “Tunable Chiroptical Properties from the Plasmonic Band to Metal-Ligand Charge Transfer Band of Cysteine-Capped Molybdenum Oxide Nanoparticles,” Angewandte Chemie International Edition 2018, 57 (32), 10236-10240; 10. Cheng, J., et al., “GoldHelix: Gold nanoparticles forming 3D helical superstructures with controlled morphology and strong chiroptical property,” ACS nano 2017, 11 (4), 3806-3818; 11. Wang, S., et al., “Guanosine Assembly Enabled Gold Nanorods with Dual Thermo- and Photoswitchable Plasmonic Chiroptical Activity,” ACS nano 2020, 14 (5), 6087-6096; 12. Yan, J., et al. “Self-assembly of chiral nanoparticles into semiconductor helices with tunable near-infrared optical activity,” Chemistry of Materials 2019, 32 (1), 476-488; and 13. Yeom, J., et al. “Chiral supraparticles for controllable nanomedicine,” Advanced Materials 2020, 32 (1), 1903878.

FIGS. 6A-6B show a schematic of an optical rotation experimental set up and a front view taken during an experiment.

FIGS. 7A-7C show molecular dynamics simulations of the atomic structure in the minimum energy state for (FIG. 7A) ligand-free, (FIG. 7B) L-NPs, and (FIG. 7C) D-NPs. The COOH group of TA ligand bonds to VO surface with bonding V—O. Each TA ligand has two COOH groups. One crystal plane of NP bonds with one COOH, another plane of NP bond with two COOH groups. The MD simulations were performed with Forcite Plus module in Materials Studio. The Universal Force Field (UFF) was applied for bonded and unbonded interactions in the models.

FIG. 8 show a cyclic voltammetry (CV) curve of a L-TA-V₂O₃ film prepared in accordance with certain aspects of the present disclosure in a two-electrode configuration.

FIGS. 9A-9H. FIGS. 9A-9B show circular dichroism (CD) and FIGS. 9C-9D show absorbance of L-TA and D-TA V₂O₃ films prepared in accordance with certain aspects of the present disclosure. FIGS. 9E-9F show reversible cycling performance of the films (CD intensity of films at 852 nanometers with zinc ions intercalation and deintercalation), while FIGS. 9G-9H show a corresponding g-factor.

FIGS. 10A-10D. FIGS. 10A-10B show STEM-EDS and FIGS. 10C-10D show HRTEM of Zn—V₂O₃ NPs prepared in accordance with certain aspects of the present disclosure.

FIGS. 11A-11D. FIGS. 11A-11B show a g-factor of L- and D-V₂O₃/CNT films prepared in accordance with certain aspects of the present disclosure. FIGS. 11C-11D show a g-factor of L- and D-V₂O₃/Ag NWs films prepared in accordance with certain aspects of the present disclosure.

FIG. 12 shows a schematic illustrating CD reversibility and Zn²⁺ storage mechanism upon electrochemical charge and discharge processes in a chiral nanoparticle prepared in accordance with certain aspects of the present disclosure.

Corresponding reference numerals indicate corresponding parts throughout the several views of the drawings.

### DETAILED DESCRIPTION

Example embodiments are provided so that this disclosure will be thorough and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/of” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

By way of background, chiral ceramics nanostructures are often prepared from metal oxides, nitrides, carbides and silicate with chiral geometry at atomic, molecular, nano, mesoscopic and micron scales, including chiral ceramic nanoparticles (NPs), mesoscopic assemblies and films. Only a minor portion of chiral ceramic materials have been investigated so far and yet the studies have demonstrated conceptual developments in magnetism, catalysis, optoelectronics, photonics, plasmonics, chiroptical devices, nanosensors, and nanomedicine. Among them, chiral non-stoichiometric metal oxides may be particularly promising due to a wide range of chemical, physical and biological properties, providing a broad range of applications. However, metal oxides with natural chiral lattice are not common. Computational models and experimental data indicate that chiral ligands can transfer their mirror asymmetry to the inorganic lattice in small nanoparticle (NPs), which results in strong optical activity enabling structurally-tunable chiroptical activity in a wide spectral range from ultraviolet to infrared region.

In the past, chirality-based nanodevices, such as optical reporters, circular polarized light (CPL) detectors, circular polarizers, sensor, memory devices, spintronic devices, electron acceptors, optical switching, THz modulators, transistors, and the like, have attracted much attention. The idea of dynamically tunable chiroptical responses is attractive because they can achieve for instance, reversible real-time magnetic field modulation and temperature-dependent reversible chiroptical activity. Typically, real-time modulation of the optical activities of NPs systems are associated with irreversible chemical changes, limiting the fabrication of solid-state nanodevices with reversible chiroptical responses, which have been rarely reported yet. Some assembled layer-by-layer (LBL) films have been able to be reversibly reconfigured and cyclically modulated by twisting, stretching, or other induced mechanical strain. These real-time modulations of the polarization rotation can be achieved over thousands of cycles. However, it would be most desirable to have the ability to have voltage-driven modulation of properties for devices. The present disclosure contemplates using metal oxide chiral ceramic nanostructures in devices that exhibit voltage-driven changes in chiroptical activity.

By way of example, conductive films including chiral vanadium (III) oxide (V₂O₃) nanoparticles have been demonstrated to have voltage-driven modulation of chiroptical activity. The chiroptical activity of such a film can be reversibly and cyclically modulated through ion intercalation and deintercalation by applying extra voltage, corresponding to a reversible change of lattice distortion of V₂O₃ NPs. In addition, the cycle number may be significantly improved by adding additional electrically conductive particles, such as carbon nanotubes (CNTs) or silver (Ag) nanowires (NWs) in the chiral V₂O₃ films, due to the enhanced conductivity.

In various aspects, the present disclosure provides a nanoparticle that exhibits reversible chiroptical activity. The nanoparticle may include an electrically conductive metal oxide having an intercalatable lattice structure into which an ion, such as a metal ion, like zinc (Zn²⁺), can reversibly intercalate. The nanoparticle may have at least one organic chiral ligand attached to a surface of the electrically conductive metal oxide. The nanoparticle may exhibit a first chiroptical state having a first chirality when the ion is intercalated into the intercalatable lattice structure of the electrically conductive metal oxide. The nanoparticle may exhibit a distinct second chiroptical state when the ion is absent from the intercalatable lattice structure. An electric force field applied to the nanoparticle may modulate chiroptical activity, for example, by facilitating migration, ingress, or egress of the ions from the intercalatable lattice structure of the nanoparticle. As such, ions may migrate into or out of the lattice structure of the nanoparticles of the present disclosure when an electric force field is applied, modified, or removed thus providing the ability to modulate the optical properties of the nanoparticle based on a presence, absence, and/or an amount of the electric field applied.

A “nanoparticle” is a solid or semi-solid material that may have a variety of shapes or morphologies and may include nanostructures or assemblies of nanoparticles. However, a nanoparticle is generally understood by those of skill in the art to mean that the particle/structure has at least one spatial dimension that is less than or equal to about 10 micrometers (10,000 nanometers). In certain aspects, a longest dimension of a nanoparticle may be less than or equal to about 5 micrometers. In certain other aspects, a nanoparticle may have at least one spatial dimension, such as length, that is greater than or equal to about 2 nanometers and less than or equal to about 5 micrometers, optionally greater than or equal to about 2 nanometers and less than or equal to about 3 micrometers, optionally greater than or equal to about 2 nanometers and less than or equal to about 1 micrometer, optionally greater than or equal to about 2 nanometers and less than or equal to about 500 nanometers, optionally greater than or equal to about 2 nanometers and less than or equal to about 100 nanometers. It should be noted that other dimensions of the nanoparticle might exceed the nanoparticle range, so long as one dimension falls within the nanoparticle ranges. In certain variations of the present disclosure, at least one dimension of the nanoparticle may be less than or equal to about 50 nanometers, optionally less than or equal to about 25 nanometers, optionally less than or equal to about 15 nanometers, optionally less than or equal to about 10 nanometers, and in certain aspects, optionally less than or equal to about 5 nanometers. In certain variations, such a nanoparticle may have an average diameter of greater than or equal to about 0.5 nanometers to less than or equal to about 25 nanometers and in certain variations, optionally greater than or equal to about 1 nanometer to less than or equal to about 5 nanometers, for example, optionally greater than or equal to about 2 nanometers to less than or equal to about 3 nanometers.

Chirality of a nanoparticle means that a nanoparticle or nanostructure exhibits asymmetrical optical activity with different handedness, for example, clockwise to form left-handed chirality (S or L orientation) and counterclockwise to form right-handed chirality (R or D orientation). Dichroism is a property where electromagnetic or light waves with differing polarization are absorbed in differing amounts by a material. Light in the form of a plane wave in space may be linearly polarized. Light is a transverse electromagnetic wave, but natural light is generally unpolarized with all planes of propagation being equally probable. Circular polarized light (CPL) typically has two perpendicular electromagnetic waves of equal amplitude and 90 degrees difference in phase and may have either a left-handed orientation (where the electric vector of light originating from a source appears to rotate clockwise) or a right-handed orientation (where the electric vector of light originating from a source appears to rotate counterclockwise). Circular polarized light may be produced by passing linearly polarized incident light through a quarter-wave plate at an angle of 45 degrees to the optic axis of the plate, for example. For example, circular polarized light may include left-hand circular (LHC) and right-hand circular (RHC) light. Elliptical polarized light is light that has two perpendicular waves of unequal amplitude that differ in phase by 90 degrees. Circular dichroism is a property where circularly polarized light waves are absorbed in differing amounts and may be referred to as spin angular momentum; because LHC and RHC polarized light represent two possible spin angular momentum for a photon.

In certain aspects, the present disclosure provides a nanoparticle that includes an electrically conductive metal oxide. The metal oxide may define an intercalatable lattice structure into which at least one ion can reversibly intercalate. In certain variations, the ion may be a metal ion, such as a zinc ion (Zn²⁺). In certain variations, the ion may be a metal ion including a metal selected from the group consisting of: zinc (Zn), vanadium (V), cobalt (Co), iron (Fe), manganese (Mn), and combinations thereof. The electrically conductive metal oxide may exhibit an electrical conductivity of greater than or equal to about 1.5×10³ S/cm.

The nanoparticle may further include at least one chiral ligand, such as an organic chiral ligand, attached to a surface of the electrically conductive metal oxide. In this manner, the at least one chiral ligand can impart a chirality to the metal oxide material. As noted above, the metal oxide may be desirably electrically conductive and thus capable of conducting electrical energy (voltage or current). The nanoparticle may be responsive to an electric force field and can thus modulate chiroptical activity. As will be explained further below, application of an electric field to the nanoparticles can serve to transport the ions into or out of the lattice structure of the metal oxide of the nanoparticle, which can modulate the chiral activity of the nanoparticle. The nanoparticles prepared in accordance with the present disclosure can exhibit a first chiroptical state having a first chirality when an ion is intercalated into the intercalatable lattice structure of the electrically conductive metal oxide and the nanoparticle exhibits a distinct second chiroptical state when the ion is absent from the intercalatable lattice structure. The second chiroptical state may be a different amount of chirality than a first amount of chirality associated with the first chiroptical state or may be an absence of chirality, as described further below.

In certain variations, the inorganic material forming the nanoparticle may be selected from the group consisting of: vanadium oxides, cobalt oxides, iron oxides, manganese oxides, and combinations thereof. In certain variations, the metal oxide may be selected from the group consisting of: vanadium (III) oxide (V₂O₃), cobalt (II, III) oxide (Co₃O₄), iron (III) oxide (Fe₂O₃), manganese dioxide (MnO₂), and combinations thereof. In certain aspects, the inorganic material may include vanadium (III) oxide (V₂O₃ also known as vanadium trioxide).

The nanoparticle may further include at least one organic ligand attached to the inorganic material, namely the metal oxide that may define a core region of the nanoparticle. The at least one organic ligand may be a chiral moiety. In certain aspects, the at least one organic ligand is an organic moiety that includes at least one functional group, for example, two or more functional groups. Organic ligands may include compounds or moieties carrying two or more functional groups that can bind to the surface of inorganic core via covalent, ionic, coordination hydrogen bonds, as well as by van der Waals interactions, London dispersion forces, Kasimir forces and other chemical and physical interactions. Thus, in certain variations, the functional group(s) of the organic ligand are capable of associating with the inorganic material in the core via at least one mechanism selected from the group consisting of: covalent bonding, ionic bonding, coordination hydrogen bonding, and combinations thereof.

In certain aspects, the functional groups may be carboxylic acid groups.

Examples of chiral organic ligands suitable for use in the nanoparticles prepared in accordance with the present disclosure may include by way of non-limiting example, tartaric acid, malic acid, penicillamine, and combinations thereof. In certain variations, the chiral ligand includes L- and/or D-enantiomers of tartaric acid (TA), which can serve not only to impart chirality to the nanoparticle but may also serve as a reducing agent. In another variation, malic acid (MA) L- and D-enantiomers may be used as organic surface ligands, for example. In yet another variation, the organic ligand may be L- and D-penicillamine (Pen).

The chiral organic ligand(s) can thus impart lattice distortions within the inorganic metal oxide material of the nanoparticle, which can enhance chiroptical activity of the nanoparticle.

In certain aspects, the nanoparticles according to the present disclosure may be distributed in another material, such as a liquid, solid, semi-solid, or gel to form an active layer. The materials may be transparent for certain select ranges or types of light waves, such as electromagnetic waves in the ultraviolet light (UV) range having wavelengths of about 100 nanometers to about 390 nanometers, visible light having wavelengths ranging from about 390 nanometers to about 750 nanometers and infrared radiation (IR) (including near infrared (NIR) ranging from about 0.75 micrometer to about 1.4 micrometers; short wave infrared (SWIR) ranging from about 1.4 micrometers to about 3 micrometers; mid wave infrared (MWIR) ranging from about 3 micrometers to about 8 micrometers; long wave infrared (LWIR) ranging from about 8 micrometers to about 15 micrometers; and far infrared (FIR) ranging from about 15 micrometers to 1 millimeter). In one example, the material may be transparent for circularly polarized light beams in the ultraviolet range. The nanoparticles may be combined with polymeric materials to form nanocomposites.

The nanocomposites incorporating the nanoparticles may be films that are transparent or transmissible to wavelengths of electromagnetic energy, such as UV, visible, or NIR, by way of example. Thus, in certain aspects, a transparent nanocomposite or thin film transmits greater than or equal to about 60% of electromagnetic energy at the predetermined range of wavelengths, optionally of greater than or equal to about 65%, optionally greater than or equal to about 70%, optionally greater than or equal to about 75%, optionally greater than or equal to about 80%, optionally greater than or equal to about 85%, optionally greater than or equal to about 90%, and in certain preferred aspects, optionally greater than or equal to about 95% of the electromagnetic energy at the predetermined range of wavelengths (e.g., in the near infrared, visible and/or ultraviolet ranges of the spectrum) is transmitted.

The nanoparticles may have a variety of shapes, for example, they may be substantially round, have an axial geometry, or have alternative shapes such as ovals, oblate structures, blades, propellers, petals, and the like. Axial geometry particles are anisotropic and have a cylindrical, rod, tube, or fibrous shape with an evident elongated longitudinal axis, which is longer than the other dimensions (e.g., diameter or width), thus having an axial anisotropic geometry. Generally, an aspect ratio (AR) for cylindrical or round shapes (e.g., a wire, pillar, a rod, tube, fiber, etc.) is defined as AR=L/D, where L is the length of the longest axis (here the major longitudinal axis) and D is the average diameter of the particle. Substantially round-shaped particles include nanoparticles having low aspect ratios and a shape including spherical, spheroidal, hemispherical, disk, globular, annular, toroidal, cylindrical, discoid, domical, egg-shaped, elliptical, orbed, oval, and the like. In certain aspects, certain nanoparticles may self-assemble with other nanoparticles to form a supraparticle including a plurality of the nanoparticles.

For example, it is believed that due to interparticle interactions, certain nanoparticles can spontaneously self-assemble into larger suprastructures driven by the inter-nanoparticle forces to form a supraparticle or mesoscale chiral ceramic (MECHIC) particle. By way of example, the supraparticle including the plurality of self-assembled nanoparticles may form a more complex shape, such as a bowtie, hourglass, or a nanoflower, like a chrysanthemum, by way of example. Such supraparticles may have a maximum dimension, for example, a diameter or a length that is substantially greater than the individual chirooptical nanoparticle, for example, greater than 100 nanometers to less than about 1 micrometer, by way of non-limiting example.

Such nanoparticles are useful in a variety of applications, including but not limited to, biosensing, telecommunication, detection devices, like light detection and ranging (LIDAR), optical and magnetooptic devices, display technologies, information technologies, diffraction-free patterning, chiral catalysis, and the like. Such nanoparticles may be chiral ceramic nanoparticles, which may form self-assembled supraparticles. Various examples of devices utilizing materials include, but are not limited to, optical devices, optical modulators, faraday rotators, memory devices, LIDARs, virtual reality goggles, holography devices, biosensors, magnetooptic displays, magnetooptical images, and others.

In certain aspects, the present disclosure provides a structure including a composite, such as a nanocomposite. In other aspects, the present disclosure contemplates a multilayered structure having at least two layers, where at least one layer includes a polymeric material and at least one layer (which may be the same or different from the layer having the polymeric material) includes a plurality of chiral nanoparticles described above. The polymeric material may be a composite or nanocomposite material. The composite material may include a matrix material, such as a polymer, a polyelectrolyte, or other matrix (e.g., cellulose paper), and at least one reinforcement material (which may be the chiral nanoparticles or other filler particles, such as the conductive particles) distributed therein. In certain aspects, the present disclosure pertains to nanocomposite materials that are composite materials including a reinforcement nanomaterial, such as nanoparticles. The composite may be in the form of a sheet or film in certain variations.

Therefore, composites formed in accordance with certain aspects of the present disclosure may have a polymer forming a matrix and a plurality of nanoparticles as a reinforcement phase. Thus, such a nanocomposite may include at least one polymer and a plurality of nanoparticles exhibiting reversible chiroptical activity. Each respective nanoparticle may be any of those described above. The polymer may be selected to be transparent or transmissive to a wavelength or range of wavelengths of electromagnetic radiation, such a visible light, infrared light, or the like. In certain variations, the at least one polymer may be selected from the group consisting of: poly(dimethyldiallylammonium chloride) (PDDA)(a positively charged or cationic polymer), poly(acrylic acid) (PAA) (a negatively charged or anionic polymer), polystyrene sulfonate (PSS)(negatively charged or anionic polymer), and combinations thereof.

The nanocomposite may further include one or more electrically conductive particles, for example, electrically conductive nanoparticles (in addition to the electrically conductive chiral nanoparticles described above) may be formed of a variety of conductive materials including metallic, semiconducting, ceramic, and/or polymeric nanoscale particles having plurality of shapes. The nanoparticles may include conductive materials, such as carbon, graphene/graphite, graphene oxide, gold, silver, copper, aluminum, nickel, iron, platinum, silicon, cadmium, mercury, lead, molybdenum, iron, and alloys or compounds thereof. Thus, suitable nanoparticles can be exemplified by, but are not limited to, nanoparticles of graphene oxide, graphene, gold, silver, copper, nickel, iron, carbon, platinum, silicon, seedling metals, CdTe, CdSe, CdS, HgTe, HgSe, HgS, PbTe, PbSe, PbS, MoS₂, FeS₂, FeS, FeSe, WO₃, and other similar materials known to those of skill in the art. In certain variations, the nanoparticles can include carbon nanotubes, such as single walled nanotubes (SWNTs) or multi-walled nanotubes (MWNTs), for example. Single-walled carbon nanotubes (SWNT) are formed from a single sheet of graphite or graphene, while multi-walled carbon nanotubes (MWNT) consist of multiple cylinders arranged in a concentric fashion. The typical diameters of SWNT can range from about 0.8 nanometer to about 2 nanometers, while MWNT can have diameters in excess of 100 nanometers. In other aspects, the electrically conductive particles may include electrically conductive metal nanowires, such as silver, gold, or copper nanowires. Suitable silver nanowires may have a length of about 15 micrometers to about 40 micrometers and a dimeter of about 100 nanometers. Other electrically conductive materials known in the art may also be used.

In certain aspects, nanocomposites prepared in accordance with the present disclosure may further include one or more electrically conductive particles, for example, those selected from the group consisting of: carbon nanotubes, electrically conductive metal nanowires (e.g., silver, gold, copper nanowires), graphene oxide, graphene, and combinations thereof. In certain variations, the electrically conductive particle for the nanocomposite may be selected from the group consisting of: carbon nanotubes, silver nanowires, and combinations thereof.

In certain aspects, the nanocomposite may include a total amount of a plurality of nanoparticles, including the electrically conductive chiral nanoparticles, of greater than or equal to about 1% by weight to less than or equal to about 97% by weight, optionally greater than or equal to about 3% by weight to less than or equal to about 95% by weight, optionally greater than or equal to about 5% by weight to less than or equal to about 75% by weight, optionally greater than or equal to about 7% by weight to less than or equal to about 60% by weight, optionally greater than or equal to about 10% by weight to less than or equal to about 50% by weight of a total amount of nanoparticles in the nanocomposite. Of course, appropriate amounts of nanoparticles in a composite material may depend upon material properties, percolation thresholds, and other parameters for a particular type of nanoparticle in a specific matrix material.

In certain variations, the nanocomposite may include a total amount of a polymer matrix material of greater than or equal to about 1% by weight to less than or equal to about 97% by weight, optionally greater than or equal to about 10% by weight to less than or equal to about 95% by weight, optionally greater than or equal to about 15% by weight to less than or equal to about 90% by weight, optionally greater than or equal to about 25% by weight to less than or equal to about 85% by weight, optionally greater than or equal to about 35% by weight to less than or equal to about 75% by weight, optionally greater than or equal to about 40% by weight to less than or equal to about 70% by weight of a total amount of matrix material in the nanocomposite.

In certain variations, the nanocomposite defines a multilayered structure, which may be formed by a layer-by-layer process described below. A first layer may thus include positively charged poly(dimethyldiallylammonium chloride) (PDDA) and a second layer may include negatively charged poly(acrylic acid) (PAA) and the plurality of nanoparticles. In certain variations, the second layer may further include the electrically conductive particle(s). The first and second layers may form an alternating multilayered nanocomposite structure.

In one aspect, a multilayered coating or composite may be formed by a layer-by-layer deposition process that includes a plurality of positive layers interspersed with a plurality of negative layers. The nanocomposite may be formed on a substrate, which may be transparent to select wavelengths of light, for example ultraviolet, visible light, or infrared light as described previously above. The nanocomposite may remain on the substrate or be removed after formation. The substrate may be used as-is or may be treated to impart or enhance a desired charge, for example, being plasma etched (e.g., oxygen plasma treatment), being treated with chemicals, electron beam, or high intensity lasers, for example. Suitable examples of substrates include a glass, dielectric-based, or polymeric substrate. In certain aspects, the substrate may include indium tin oxide (ITO), silicon dioxide, silicon, borosilicates, and the like, by way of non-limiting example. Suitable polymeric substrates optionally include polyesters, such as polyethylene terephthalate (PET), polyethylene naphthalate or (poly(ethylene 2,6-naphthalate) (PEN), polycarbonates, polyacrylates and polymethacrylates, including poly(methylmethacrylate) (PMMA), poly(methacrylate), poly(ethylacrylate), siloxanes, like polydimethylsiloxane (PDMS), and the like.

A method of making such a nanocomposite may be a layer-by-layer technique. The LBL technique is well known and relies on alternating adsorption of charged species or polyelectrolytes onto a substrate. Layers may be built up by sequential dipping of a substrate into oppositely charged solutions having oppositely charged moieties that are attracted to the surface. Additional steps may occur between application steps, such as washing of the surface before application of the next material. Monolayers of individual components attracted to each other by electrostatic and van-der-Waals interactions are thus sequentially adsorbed on the substrate. Multiple deposition cycles of first and second charged materials can be repeated sequentially to build alternating layers in a multilayered structure. A composite material layer may include a first charged material or a second charged material. Depending on the charge of the substrate, the first charged material may be either a polycation or a polyanion (so that it is attracted to and deposited onto the surface of the substrate). Thus, the second charged material is the other of the polycation or the polyanion, having an opposite charge to the first charged material. Accordingly, a composite coating or layered material formed by LBL is often referred to as: (polyanion/polycation)ₙ, where n represents the number of deposition cycles or layers present. LBL films or coatings can be constructed on a variety of solid substrates, thus imparting much flexibility for size, geometry and shape and further patterned or etched (with chemicals, plasma, electron beam, or high intensity lasers, for example).

Thus, the methods may include applying a first charged material having a first polarity to at least one surface of a substrate having a second polarity opposite to the first polarity. The method also include applying a second charged material having the second polarity over the first charged material in a layer-by-layer process on the at least one surface. The first charged material and the second charged material are distinct from one another and define a layer (e.g., a layered coating). The method further includes applying a plurality of chiral nanoparticles with one of the first or second charged materials so that they are incorporated into one of the layers. Further, one or more electrically conductive materials may be applied with the first or second charged materials to be incorporated into one of the layers formed. The chiral nanoparticles and the electrically conductive particles may be applied in the same layer.

In one aspect, the first charged material includes a cationic poly(dimethyldiallylammonium chloride) (PDDA) and the second charged material includes an anionic poly(acrylic acid) (PAA). The plurality of chiral nanoparticles may have the first or second polarity.

In one aspect, the plurality of chiral nanoparticles are stabilized with a chiral organic ligand, for example, including at least one of L-tartaric acid or D-tartaric acid.

The nanocomposite may have a thickness of greater than or equal to about 10 nanometers to less than or equal to about 1 millimeter, optionally greater than or equal to about 10 nanometers to less than or equal to about 500 micrometers, and in certain variations, optionally greater than or equal to about 25 nanometers to less than or equal to about 250 micrometers.

The nanocomposite including the plurality of electrically conductive chiral nanoparticles and supplemental electrically conductive particles may exhibit an electrical conductivity of greater than or equal to about 1.5×10³ S/cm. In certain aspects, the nanocomposite has an electrical conductivity of greater than or equal to about 1×10⁵ S/cm, optionally greater than or equal to about 1.1×10⁵ S/cm, optionally greater than or equal to about 1×10⁶ S/cm, optionally greater than or equal to about 2×10⁶ S/cm, optionally greater than or equal to about 3×10⁶ S/cm, optionally greater than or equal to about 4×10⁶ S/cm, optionally greater than or equal to about 5×10⁶ S/cm, optionally greater than or equal to about 6×10⁶ S/cm, optionally greater than or equal to about 7×10⁶ S/cm, optionally greater than or equal to about 8×10⁶ S/cm, and in certain variations, optionally greater than or equal to about 8.6×10⁶ S/cm.

In certain other aspects, the nanocomposite material may include the plurality of electrically conductive chiral nanoparticles and a plurality of electrically conductive nanoparticles as a supplemental reinforcement nanomaterial and thus may have an electrical resistivity of less than or equal to about 1×10⁻⁴ Ohm·m, optionally less than or equal to about 9×10⁻⁵ Ohm·m, optionally less than or equal to about 8×10⁻⁵ Ohm·m, optionally less than or equal to about 7×10⁻⁵ Ohm·m, optionally less than or equal to about 6×10⁻⁵ Ohm·m, optionally less than or equal to about 5×10⁻⁵ Ohm·m, optionally less than or equal to about 4×10⁻⁵ Ohm·m, optionally less than or equal to about 3×10⁻⁵ Ohm·m, optionally less than or equal to about 2×10⁻⁵ Ohm·m, optionally less than or equal to about 1×10⁻⁵ Ohm·m, optionally less than or equal to about 9×10⁻⁶ Ohm·m, optionally less than or equal to about 8×10⁻⁶ Ohm·m, optionally less than or equal to about 7×10⁻⁶ Ohm·m, optionally less than or equal to about 6×10⁻⁶ Ohm·m, optionally less than or equal to about 5×10⁻⁶ Ohm·m, optionally less than or equal to about 4×10⁻⁶ Ohm·m, optionally less than or equal to about 3×10⁻⁶ Ohm·m, optionally less than or equal to about 2×10⁻⁶ Ohm·m, and in certain embodiments, optionally less than or equal to about 1×10⁻⁶ Ohm·m.

In certain other variations, an impedance (Z) of the electrically conductive nanocomposite may be less than or equal to about 1×10⁴ Ohms (e.g., measured using an AC sinusoidal signal of 25 mV in amplitude with impedance values measured at a frequency of 1 kHz), optionally less than or equal to about 9×10³ Ohms, optionally less than or equal to about 7×10³ Ohms, optionally less than or equal to about 5×10³ Ohms, optionally less than or equal to about 3×10³ Ohms. In certain variations, such impedance (Z) of an electrically conductive nanocomposite may be less than or equal to about 1×10³ Ohms, optionally less than or equal to about 9×10² Ohms, optionally less than or equal to about 7×10² Ohms, optionally less than or equal to about 5×10² Ohms, optionally less than or equal to about 3×10² Ohms, optionally less than or equal to about 2×10² Ohms, and in certain variations optionally less than or equal to about 1×10² Ohms.

In certain further aspects, the present disclosure contemplates that the composite material is porous and includes a plurality of pores. The plurality of pores includes a plurality of internal pores and external pores that may be open to one another and form continuous flow paths or channels through the nanocomposite body/layer extending from a first external surface to a second external surface. As used herein, the terms “pore” and “pores” refer to pores of various sizes, including so-called “macropores” (pores typically of greater than 50 nanometers diameter), “mesopores” (pores typically having diameter between 2 nanometers and 50 nanometers), and “micropores” (pores typically having diameter of less than 2 nanometers) and any combinations thereof, where the pore size refers to an average or median value, including both the internal and external pore diameter sizes. The pores may thus be randomly disposed throughout while being interconnected and permitting fluid flow therethrough. In various aspects, the porous material includes a plurality of pores having an average pore size diameter of greater than or equal to about 10 nanometers to less than or equal to about 1 millimeters, optionally greater than or equal to about 20 nanometers to less than or equal to about 10 micrometers, optionally greater than or equal to an average pore size diameter of greater than or equal to about 30 nanometers to less than or equal to about 5 micrometers, optionally greater than or equal to an average pore size diameter of greater than or equal to about 40 nanometers to less than or equal to about 1 micrometers. In certain variations, an average pore size diameter of the plurality of pores in the substrate material is selected to be greater than or equal to about 50 nanometers to less than or equal to about 500 nanometers.

In certain aspects, at least one electrolyte including a salt having the ion that is capable of intercalating into the plurality of lattice structure of the electrically conductive metal oxide of the chiral nanoparticles. The electrolyte may thus be disposed in at least a portion of the plurality of pores to help facilitate ion movement into and out of the nanoparticles within the nanocomposite when the external electric field is activated or deactivated.

In one aspect, the electrolyte may be a liquid electrolyte that is imbibed into a portion of the open pores in the nanocomposite. The liquid electrolyte may include at least one salt including the ion and at least one solvent, such as an aqueous or polar solvent, like water. In certain variations, the salt is a zinc salt that releases zinc ions (Zn²⁺). The at least one zinc salt may include zinc sulfate (ZnSO₄). In one variation, the electrolyte may include e zinc sulfate (ZnSO₄) at a concentration of 2 M in water (H₂O) at a pH of about 4.2.

The present disclosure also further contemplates devices that have an optic component, such as those examples discussed above. The optic component may include one or more nanoparticles. Where a plurality of nanoparticles is present, they may be any of those described previously above. For example, each nanoparticle may include an electrically conductive metal oxide. The electrically conductive metal oxide has an intercalatable lattice structure, capable of being reversibly intercalated with at least one ion, and including a metal selected from the group consisting of: vanadium (V), cobalt (Co), iron (Fe), manganese (Mn), and combinations thereof. In certain aspects, the metal oxide may be selected from the group consisting of: vanadium (III) oxide (V₂O₃), cobalt (II, III) oxide (Co₃O₄), iron (III) oxide (Fe₂O₃), manganese dioxide (MnO₂), and combinations thereof. The nanoparticle also includes at least one organic chiral ligand attached to a surface of the electrically conductive metal oxide. As noted above, the chiral ligand may be selected from the group consisting of: tartaric acid, malic acid, penicillamine, and combinations thereof. In various aspects, each nanoparticle may be responsive to an electric force field to modulate chiroptical activity and exhibits a first chiroptical state having a first chirality when an ion is intercalated into the intercalatable lattice structure of the electrically conductive metal oxide. Each nanoparticle is also capable of exhibiting a distinct second chiroptical state when the ion is absent from the intercalatable lattice structure. The nanoparticles may be in contact with an electrolyte. For example, the nanoparticles may be distributed in a porous material where the electrolyte is imbibed in pores of the material and thus contacts at least a portion of the nanoparticles.

A device may also include an electric component that can selectively generate an electric force field directed towards the optic component. The electric force field directed towards the optic component can thus drive the ion(s) into the intercalatable lattice structure of the electrically conductive metal oxide of the plurality of nanoparticles. The electric force field generated by the electric component is thus configured to modulate chirality of an output of electromagnetic waves generated by/from the optic component. The electric component may be a power supply device that generates direct current (DC) or alternating current (AC), such as a DC generator or an AC generator, by way of non-limiting example. The device may have one or more regions in a housing that are transparent to a predetermined range of electromagnetic light waves to permit them to pass to and from the optic component. Thus, the electric force field directed towards the optic component modifies the optical properties of the plurality of electrically conductive chiral nanoparticles. Thus, in various aspects, the optic component includes optical media, such as a nanocomposite material including the plurality of electrically conductive chiral nanoparticles and light modulation using such nanoparticles under ambient conditions. By ambient conditions, it is meant that the temperature and pressure conditions can be the same as those in the surrounding environment, without any need for cooling or regulating pressure. For example, standard room temperature conditions may be about 20 to about 25° C. and standard pressure conditions may be about 1 atm or 101.325 kPa. As appreciated by those of skill in the art, such ambient conditions may vary depending on location, altitude, and weather conditions.

The optic device may further include a source of light that directs electromagnetic waves towards the optic component. The light source may be a laser that is configured to generate (i.e., emit) one or more polarized or unpolarized light pulses. The pulses may include, for example, left and right circularly polarized sequences, elliptically polarized sequences, any combination of the foregoing, or any other suitably polarized light sequences. The optic device may include various other conventional components, including lens, polarizers, filters, and the like, as well as sensors, monitors, and the like. The device may be associated with one or more detectors. The optic device may further include a control system for automated operation, which may be a microprocessor or a computer processing unit (CPU), by way of non-limiting example.

In various aspects, the present disclosure contemplates forming a nanoparticle exhibiting reversible chiroptical activity. In one variation, the nanoparticle includes an electrically conductive metal oxide having an intercalatable lattice structure, such as one that includes vanadium (V) in the form of vanadium (III) oxide (V₂O₃) and having at least one organic chiral ligand including tartaric acid attached to a surface of the V₂O₃. The nanoparticle synthesized V₂O₃ nanoparticles (NPs) are approximately 2 nanometers in diameter with high chiroptical activity in narrow bands at 401, 522, 625, and 923 nanometers. The g-factor for 1244 nanometer band is 0.08 at exceeding others in near infrared (NIR) part of the spectrum by 400 times (compared with tungsten (VI) oxide (WO₃) NPs). Taking advantage of the ability of ceramic materials to intercalate guest ions reversibly, an electrically conductive and optically transparent nanoceramic thin film with chiroptical activity is fabricated and demonstrated to have real-time modulation. For example, a circular dichroism (CD) intensity band at 870 nanometers can be reversibly modulated due to potential-driven insertion and extraction of zinc (Zn²⁺) ions altering the lattice distortions of NPs and is responsible for this polaronic band. The combination of chirality, ionic and electronic conductivity of the V₂O₃ transparent films opens a possibility for construction of chiral optoelectronic devices with strong modulation of polarization rotation across the electromagnetic (EM) spectrum. Such chiral ceramic nanostructures with high chiroptical activity can potentially provide new capabilities for real-time broad-band modulation of chiroptical activity, representing a key milestone for solid-state thin film chiroptical devices.

Embodiments of the present disclosure are further illustrated through the following non-limiting examples.

### EXAMPLES

2 nanometers V₂O₃ nanoparticles are synthesized using the L- and D-enantiomers of tartaric acid (TA) as surface ligands. The choice of vanadium oxide (V₂O₃) as the candidate for coatings toward device application was governed by its higher electrical conductivity compared to other contemplated ceramic oxides (e.g., MnO₂, Fe₂O₃, Co₃O₄, etc.). These NPs exhibited strong chiroptical activity with multiple peaks in circular dichroism (CD) spectrum across a wide spectral range from 300 nanometers to 1300 nanometers. Chiral distortions with much larger crystal lattices of V₂O₃ NPs lead to high chiroptical activity, especially, the g-factor in NIR range is approximately 400 times higher than other nanoceramics with comparable size.

The following chemicals are used in the following experiments. Vanadium (III) chloride (VCl₃, 97%), L-, D- and racemic (rac)-Tartaric acid (TA, 99%), sodium hydroxide (NaOH, 97%), L- or D-Penicillamine (Pen, 99%), poly(acrylic acid) (PAA, molecular weight (M_{w}) approximately 250,000, 35 wt. % in H₂O), poly(diallyldimethylammonium chloride) (PDDA, M_{w} 400,000-500,000, 20 wt. % in H₂O), carbon nanotube, single-walled (CNT, 98%), poly-(vinylpyrrolidone) (PVP, M_{W}=55,000), iron chloride (FeCl₃, 97%), zinc sulfate (ZnSO₄, 2 M in H₂O, pH=4.2), Zinc foil (Zn, 0.25 mm thickness, 99.9%), ethyl alcohol, acetone, isopropanol and ethylene glycol of reagent grade were all purchased from Sigma-Aldrich. L- or D-Malic acid (MA, 99%) were purchased from Alfa-Aesar. Silver nitrate (AgNO₃, 99.95%) was purchased from Fisher Chemical.

### Example 1

Synthesis of chiral vanadium oxide nanoparticles (NPs). Vanadium oxide NPs were synthesized by arrested hydrolysis of VCl₃ in water at different pH in presence of L-, D- and rac-TA serving as surface ligands on the NPs. Specifically, 0.128 g VCl₃ and 0.18 g L- or D-TA were dissolved in 60 mL E-pure water producing a solution with pH of 1.4. Using 2.5 M NaOH, pH was adjusted from 2 to 12 in 5 mL aliquots of this solution. Then, the solution was incubated at room temperature for one hour with magnetic stirring. A similar process of nanoparticle (NP) synthesis was used for other chiral ligands, such as MA (0.16 g in 60 mL E-pure water) or Pen (0.18 g in 60 mL E-pure water).

### Example 2

In a first sample, chiral V₂O₃ films are prepared. Following a process similar to that described above, 0.128 g VCl₃ and 0.18 g L- or D-TA were added to 30 mL E-pure water, adjusting pH to 3, followed by one hour incubation at room temperature with stirring. The precipitate can be obtained by centrifugation by adding two times the volume of isopropanol and centrifuged at 3000 rpm for 5 minutes. Finally, the precipitate was re-dissolved in 4 mL water to prepare an aqueous dispersion for film deposition.

An ITO substrate was cleaned sequentially with ethyl alcohol, acetone, isopropanol, water each for 20 minutes by an ultrasonic bath, then were rinsed with copious amounts of water and dried. Films were cut into 1×3.5 cm² segments in order to fit the CD test. To make the coating optically uniform and transparent, NP layers were deposited using layer-by-layer (LbL) assembly. The multilayer films were prepared by alternatively dipping ITO substrates in 0.5% w/v PDDA (0.5% w/v in water) and V₂O₃/PAA (PAA 6.0% w/v in water, 2 mL mixed with 4 mL NPs dispersion) solutions with intermediate double 1-min long immersions in pure water at pH 7. The nanoscale coating obtained after electrostatically restricted adsorption of PDDA and V₂O₃/PAA components will be denoted as a bilayer. The bilayer depositing cycle was repeated as many times as needed procedure to obtain a desired number of multilayers. Typically, each step was analyzed by UV-vis spectra.

### Example 3

In a second sample, chiral V₂O₃/carbon nanotube (CNT) films are prepared. 100 mg of CNT were added to 100 mL solution of 1 mg/mL PAA and dispersed by ultrasonication for 25 min. After centrifugation (6000 rpm, 10 min), 1 mL supernatant with dispersed CNTs was taken out in a separate vial and mixed with 4 mL above V₂O₃ NPs dispersions in water. This V₂O₃ NPs dispersion is the same as the above dispersion in Example 2 that is used in VO film, followed by 10 minutes of ultrasonication. Then the homogeneous V₂O₃/CNT solution was added into 2 mL PAA (6.0% w/v in water) solution, followed by 20 min ultrasonication. The process of LBL assembly used for V₂O₃/CNT film was identical to those for V₂O₃ film.

### Example 4

In a third sample, chiral V₂O₃/silver nanowires (Ag NWs) films are prepared. Ag NWs were synthesized by a modified polyol process. Briefly, 0.2 g of PVP (M_{W}=55 000) mixed with ethylene glycol (25 mL) were incubated at room temperature under stirring until PVP completely dissolved. Next, AgNO₃ (0.25 g) was added to the PVP solution. 3.25 g ethylene glycol solution (FeCl₃, 600 μM) was added to the aforementioned reaction mixture with stirring for 1 min. Finally, the mixture was immediately transferred into an oil bath, heated for 1 hour at 130° C., and then slowed to cool to room temperature under ambient atmosphere. The as-synthesized Ag NWs were washed with water several times to remove the reagent residues and byproducts. The NWs dispersed into water for further procedures. The Ag NWs dispersion (Abs_{600 nm} approximately 2.0, 1 mL) was mixed with 4 mL chiral V₂O₃ aqueous, followed by 10 min ultrasonication. Then the homogeneous V₂O₃/Ag NWs solution was added into 2 mL PAA (6.0% w/v in water) solution. Identical LBL assembly process as for the previous multilayers was used.

### Example 5

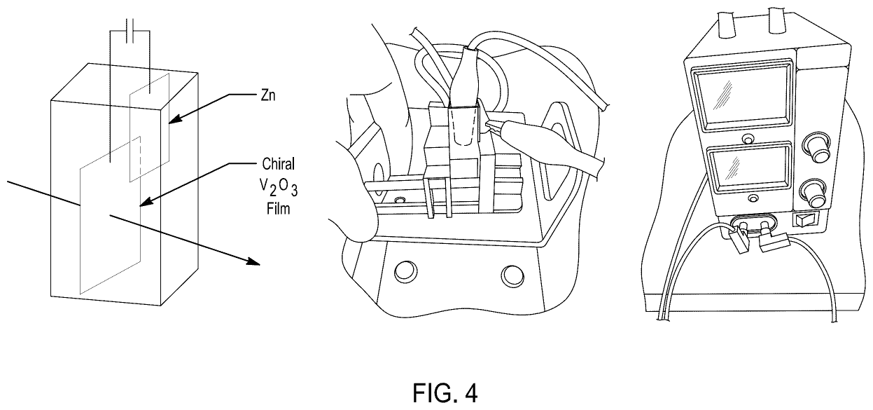

Various tests are performed on the NPs films prepared in Examples 2-4 is tested. Cyclic de/intercalation of the NPs films prepared in Examples 2-4 as follows. ZnSO₄ in water as described above was chosen as the electrolyte. During the intercalation process, the negative electrode of the voltage source was connected to the ITO substrate with multilayers having the inventive composites and the positive electrode was connected to the Zn foil. Deintercalation was achieved by reversing the voltage. The applied voltages were maintained at 1 V and 1.8 V for zinc ions intercalation and deintercalation, respectively. The amount of zinc ion insertion depends on the total coulomb and electrolysis duration. To ensure the maximum intercalation, the reaction process was finished until there is no CD modulation. The set-up of in-situ CD test are shown in FIG. 4.

Electrochemical measurements. The electrochemical properties of chiral V₂O₃ ITO films (working electrode) are investigated against a Zn foil counter (reference) electrode in a two electrode in ZnSO₄ solution electrolyte. The cyclic voltammetry was performed using a scan rate of 0.1V/s in a potential window of 0.4-1.8 V (vs Zn/Zn²⁺).

Molecular Dynamics (MD) simulations. The MD simulations were performed with Forcite Plus module in Materials Studio. The Universal force field (UFF) was applied for bonded and unbonded interactions in the models. The Coulombic force was calculated atom-based with a distance cut off of 1.55 nanometers. NVT ensemble was used at the ambient temperature of 298K, controlled by the Nose method. A time step of 1 fs was employed while the total production time was set up to 20 ns.

Characterization of nanoparticles and films prepared in Examples 2-4 was conducted as follows.

Transmission electron microscopy (TEM) and STEM-EDS. The samples were prepared by directly dropping V₂O₃ aqueous solution onto a carbon-coated TEM copper grid (400 mesh) followed by drying in air. TEM and STEM-EDS tests were carried out on TFS Talos F200X G2 transmission electron microscope with an acceleration voltage of 100 kV. High-resolution transmission electron microscopy (HRTEM) images were obtained on JEOL3100 microscope.

Scanning electron microscope (SEM) studies were carried out on TFS Nova 200 with an accelerating voltage of 1.5 kV.

X-ray photoelectron spectra (XPS) were obtained on a Kratos Analytical Axis Ultra apparatus. Putting the powders of V₂O₃ NPs or chiral ITO films on Cu tapes of bar. The working power set-up for these tests were 14 kV HT and 8 mA Emission, and all tests were done in room temperature.

X-ray diffraction patterns (XRD) were acquired on a Rigaku Ultima-4 Diffractometer using a continuous scanning mode with a scan step of 0.02 and a scan rate of 10 s per step.

Raman spectra were recorded on a laser microRaman spectrometer (Invia, Renishaw) with a 532 nanometers wavelength laser.

Fourier Transform Infrared Spectroscopy (FTIR). FTIR spectra were obtained on the bench-top Nicolet IS50 instrument by using powders.

CD measurements (JASCO J-1700). Quartz cuvettes with a 1 cm path length were used for all test with NPs solution. The CD signals of all chiral films were recorded by dipping film in ZnSO₄ electrolyte. All g factors were calculated from absorbance data measured simultaneously with a Jasco J-1700 circular dichroism spectrometer.

Preparation and properties of chiral V₂O₃ nanoparticles. Tunable chiral vanadium oxide NPs have been prepared by vanadium (III) chloride with chiral ligands in water by adjusting the reaction pH as described above in Example 1. The carboxylic groups of LID-TA strongly bind to the vanadium oxide NPs surface. NPs synthesized using TA enantiomers or their equimolar mixtures are denoted as D-, L- and rac-NPs. Note that these notations refer to the preparative method and the type of the optical center in TA coating the NP surface rather than description of specific tetrahedral geometry of chiral centers associated with these notations in organic chemistry. Subset of NPs in dispersions of V₂O₃ chiral NPs prepared can be mirror images of each other but, due to polydispersity, it does not universally apply to all NPs in these dispersions.

The chiroptical activity was also observed in V₂O₃ NPs capped with other chiral molecules, such as L- and D-MA and L- and D-Pen. Although the CD and other chiroptical spectra were less intense compared to those with TA, these data indicate that chirality transfer from chiral molecules on the surface to V₂O₃ NPs is quite general. Most of the experiments in these examples were carried out with TA-stabilized NPs due to their stronger polarization rotation in visible and NIR parts of the spectrum.

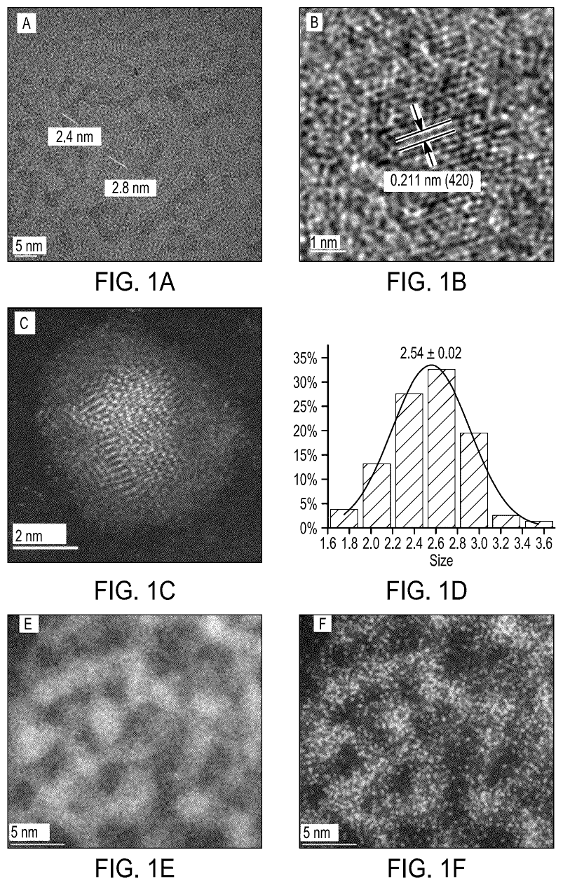

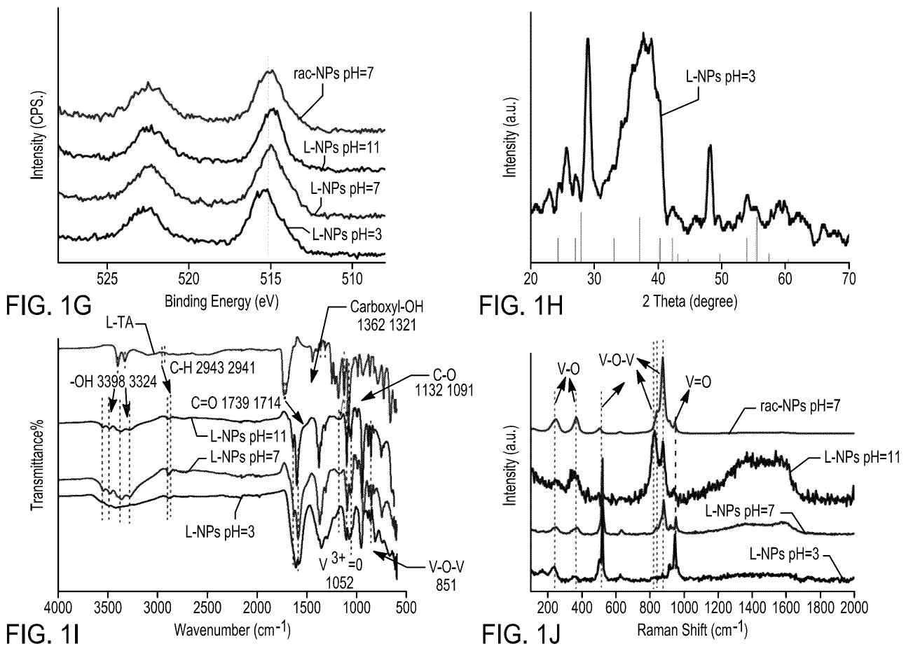

The atomic composition and valence of vanadium atoms of the NPs was established by scanning transmission electron microscopy and energy-dispersive spectra (STEM-EDS) mapping (FIGS. 1C, 1E, 1F) and X-ray photoelectron spectroscopy (XPS) (FIG. 1G). From the vanadium 2p region (FIG. 1G), it was observed that the redox state of vanadium is dominated by +3 atoms. In the FTIR spectra (FIG. 1I), the peak at 1052 cm⁻¹ is attributed to the stretching vibration of the V³⁺=O bond. Peaks at 851 cm⁻¹ are associated with the stretching vibration of V—O—V bonds. The peaks observed in complementary Raman scattering spectra with Raman shifts lower than 1000 cm⁻¹ are all attributed to the different modes of vibration of V₂O₃ (FIG. 1J). While the bands at approximately 822 and 875 cm⁻¹ are assigned to the bending vibration of V—C—V groups. However, the high frequency Raman band at 948 cm⁻¹ corresponds to the terminal oxygen (V³⁺=O) stretching mode situated most likely on the NP interface. The bands located at 245 and 366 cm⁻¹ are assigned to the bending vibration of the V—O bonds.

Transmission electron microscopy (TEM) shows that the average size of V₂O₃ NPs was approximately 2 nanometers, which was dependent on pH (FIGS. 1A and 1D). The average size of L-NPs from 2.31 nanometers to 2.54 nanometers corresponds with pH from 3 to 11. High-resolution transmission electron microscopy (HRTEM) images of L-NPs demonstrated that the crystalline domains were restricted to the central part of the NPs with lattice spacing of 0.202 nanometers or 0.211 nanometers, which were coincident with the (420) planes of V₂O₃ (FIG. 1B). Furthermore, the X-ray diffraction (XRD) 2θ-ω scans confirmed a typical monoclinic phase of V₂O₃ for these NPs (FIG. 1H).

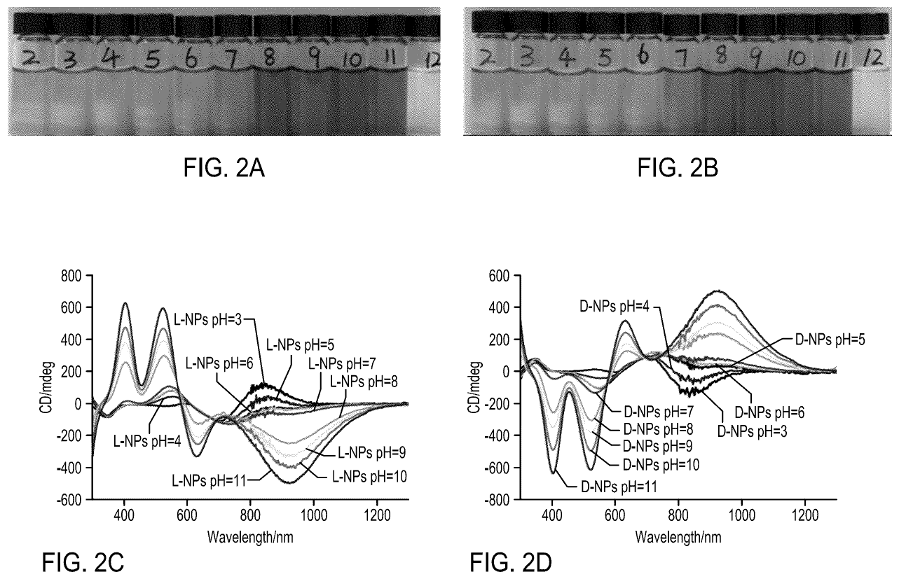

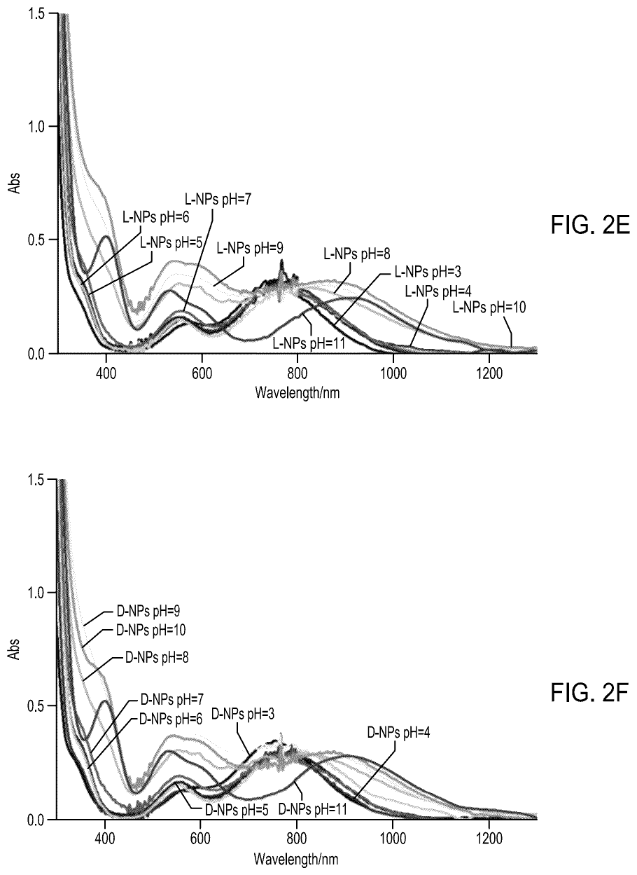

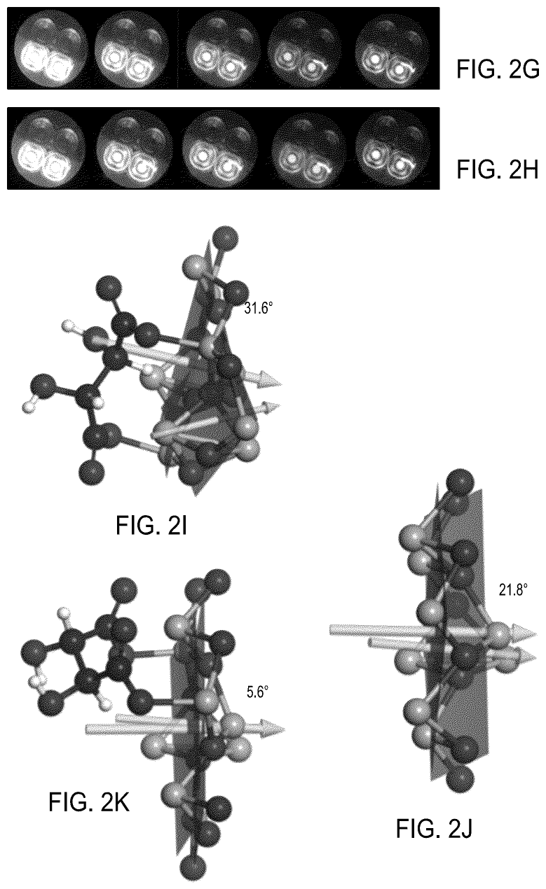

The CD spectra of LD-NPs, with multiple positive and negative peaks in from 300 nanometers to 1300 nanometers (FIGS. 2C, 2D) corresponding to various transitions, including intraparticle and ligands related surface states as was identified for structurally similar chiral Co₃O₄ and WO₃ NPs. The absorption spectrum of V₂O₃ NPs highly depends on the pH of synthesis process, which directly determines the configuration of ligand molecular on the surface of NPs (FIGS. 2E and 2F). As expected, CD spectrum disappears in rac-NPs while displaying very similar UV-vis absorption spectrum. The polaron absorption peak of L-NPs exhibited a blue-shift from 923 nanometers to 758 nanometers with pH changing from 11 to 3 (FIG. 2E). These peaks origin from the different polaron transitions. Different polarization states correspond to various lattice distortions related to chiroptical activity.

Interestingly, the same change in pH causes CD peak in NIR spectral range to be gradually shifted from 921 nanometers to 841 nanometers and change its sign from negative to positive with decreasing pH (FIG. 2C). For the D-NPs, both CD spectra and absorption spectra showed a similar shift with lowering of pH (FIGS. 2D-2F) and opposite signs of the peaks. FIGS. 2A and 2B showed the different color of chiral LID-NPs with pH varying from 2 to 12, the chiroptical signal annihilated when pH reaches 12 and the dispersion of NPs became colorless. The chiral NPs with a pH of 2 are almost colorless along with weak CD peaks. The g-factor in NIR corresponding to the first polaron absorption peak decreases gradually with pH decreasing from 11 to 2, as shown in Table 1,

TABLE 1
Spectroscopic parameters of L- and D- NPs corresponding
to NIR peaks for NPs synthesized at pH from 2 to 11.

| | L-NPs | | D-NPs | |
|---|---|---|---|---|
| pH | λ_{CD}/nm | g-factors | λ_{CD}/nm | g-factors |
| 2 | 906 | 0.007 | 906 | −0.012 |
| 3 | 898 | 0.025 | 900 | −0.024 |
| 4 | 1031 | −0.009 | 1020 | 0.008 |
| 5 | 1041 | −0.030 | 1001 | 0.020 |
| 6 | 991 | −0.014 | 986 | 0.019 |
| 7 | 1001 | −0.023 | 1036 | 0.029 |
| 8 | 996 | −0.039 | 998 | 0.034 |
| 9 | 975 | −0.044 | 975 | 0.039 |
| 10 | 963 | −0.047 | 981 | 0.046 |
| 11 | 1244 | −0.079 | 1240 | 0.071 |

The highest g-factor of L/D-NPs in the NIR region is 0.079 at 1244 nanometers, which is approximately 400 times higher than the WO₃ NPs.

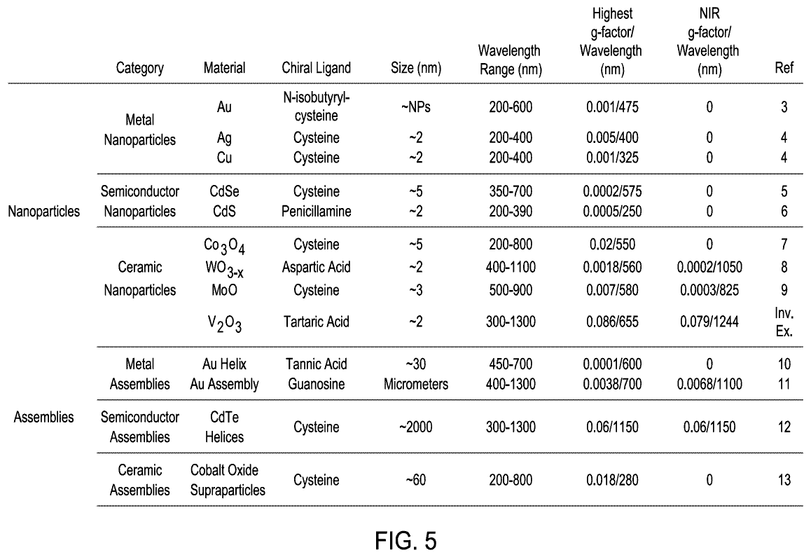

The analysis indicates that g-factors for these films are much better than for helices films (0.0072) and similar chiral materials for the 1200 nanometers range by comparison as shown in FIG. 5.

Although many NPs have absorption in the NIR, there is little CD signal observed in long wavelength. The strong chiroptical activity is same as micron scale CdTe assemblies and dramatically higher than Au nanorods hydrogels. V₂O₃ NPs show an absolute superiority in both highest g-factor and NIR g-factor as compared to several chiral NPs and assembles reflected in FIG. 5. A high g-factor for any specific wavelength in the UV-Vis-NIR range can be successfully achieved by controlling the pH to satisfy a certain need and application (Table 2).

TABLE 2
CD anisotropic factors of L/D-TA V₂O₃ NPs (pH = 2-11).

| | L-NPs | | D-NPs | |
|---|---|---|---|---|
| pH | λ_{CD}/nm | g-factors | λ_{CD}/nm | g-factors |
| 2 | 679 | −0.010 | 691 | 0.008 |
| 3 | 898 | 0.025 | 900 | −0.024 |
| 4 | 687 | −0.015 | 662 | 0.020 |
| 5 | 532 | 0.016 | 507 | −0.021 |
| 6 | 483 | 0.030 | 500 | −0.020 |
| 7 | 1001 | −0.023 | 1036 | 0.029 |
| 8 | 499 | 0.043 | 512 | −0.029 |
| 9 | 975 | −0.044 | 975 | 0.039 |
| 10 | 963 | −0.047 | 981 | 0.046 |
| 11 | 654 | −0.086 | 655 | 0.084 |

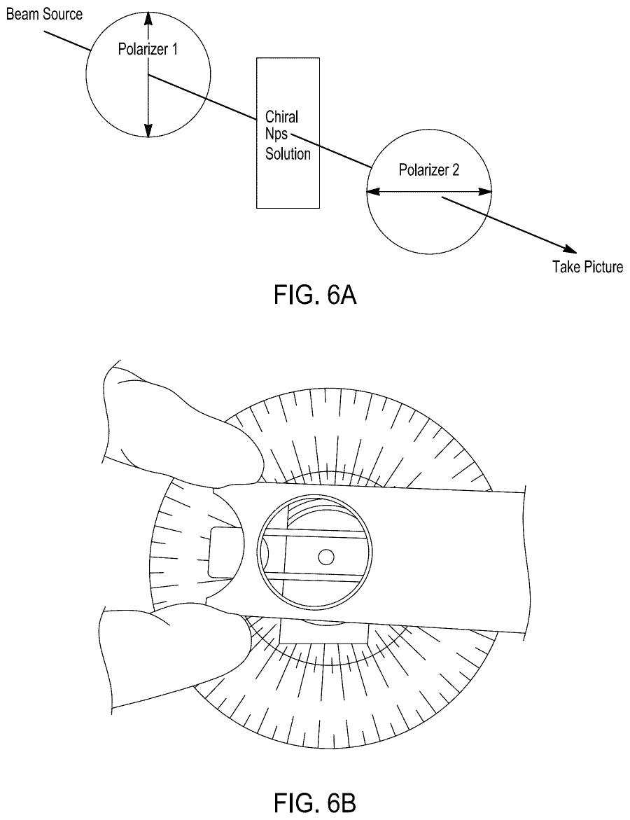

The highest value of the g-factor in the visible range attained 0.086, the strongest chiral NPs ever found compared to other NPs of similar size and for non-plasmonic particles, which can be observed directly by naked eyes as the appearance of a series of full color when white light passes through the NPs by rotating one of crossed polarizer (FIGS. 2G-2H, 6A-6B (showing optical rotation set-up)). For L-NPs, the color continuously changed from red to purple by clockwise rotating the polarizer-2, while D-NPs exhibits a similar evolution of full color by counterclockwise rotation. The red/green/blue/purple color corresponds to the multiple peaks of 655/502/450/402 nanometers in the g-factor spectra observed.

The strong chiroptical activity of V₂O₃ NPs with high g-factor is an inevitable product of the lattice distortions induced by chiral molecules. There could be distortions in it but it is not yet clear in which part of the NPs. This strong distortion of the inorganic crystal lattice is a characteristic of the ceramic NPs, it has been observed in other nanoceramic oxides with similar synthesis processes. The configuration of lattice distortion appears in the vicinity of the NP surface induced by TA enantiomers, and it is considered as a chiral amorphous inorganic layer, which can be proved by STEM (FIG. 1C). In the examples, NPs with pH 11 show the highest g-factor compared with other NPs synthesized at pH=2-10 (Table 2). NPs with pH 11 show big differences in the STEM and TEM statistical size, indicating NPs with pH 11 have a large amorphous layer with high distortion on inorganic core, corresponding to a higher g-factor.

Beyond that, the original broad negative CD peak of L-TA molecule split into three new peaks, including two positive peaks and one weak negative peak, corresponding to three transitions produced by the interaction between L-TA and NPs surface, elucidating the nanoceramic chirality. Similar to free L- and D-TA with symmetrical CD peak, D-TA and L-TA reveal classical mirror-image CD spectra after conjugating with NPs. A strong CD response might be induced by the chiral distortion of inorganic cores. Raman scattering spectra validated the chirality of the inorganic cores in the NPs. Characteristic bands at XXX cm⁻¹ observed for D- and L-NPs are associated with Raman-active vibration modes of V₂O₃. The peaks displayed below 1000 cm⁻¹ correspond to the characteristic features of crystalline vanadium oxide as reported previously.

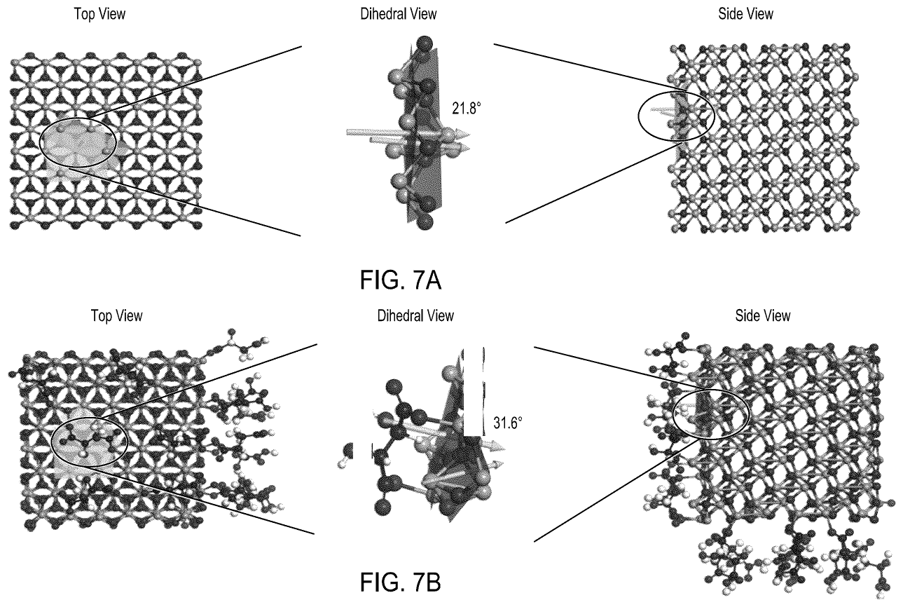

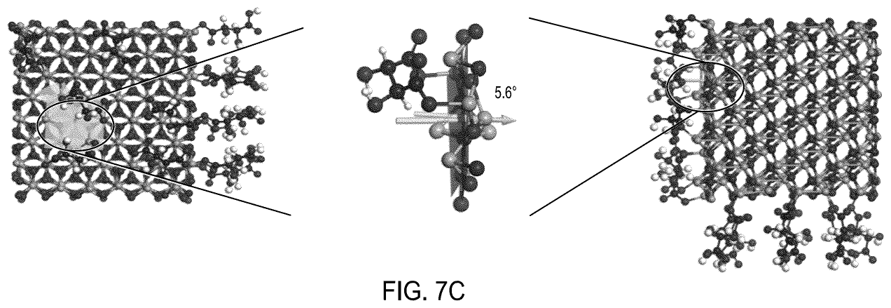

Molecular dynamics (MD) simulations in V₂O₃ NPs with either L- or D-TA surface ligands attached on the surface were performed to further confirm that the surface crystal lattice distortions breed the distortions in inorganic core. Using Forcite Plus module in Materials Studio, a ligand-free model of the monoclinic V₂O₃ NPs with the lateral size of 1.9×2.0×2.2 nm was established (FIGS. 7A-7C). The atomic motion of the constituent atoms was described by the Universal Force Field (UFF) that includes potentials for vanadium atoms. L- and D-TA surface ligands were attached to the V₂O₃ surface through the double-point binding, which was identified by FTIR results (FIG. 1I). The wavenumber of —OH, C═O and C—O shift after binding to NPs, which is consistent with the formation of coordination bonds between an oxygen atom of the hydroxy/carboxyl groups of TA and the vanadium on the NP surface. Compared with the ligand-free NPs (21.8°), the dihedral angle calculated from MD models for L-NPs became larger (31.6°), while that for D-NPs decreased to 5.1°, indicating the stacking lattice of V₂O₃ NPs distorted towards opposite directions after decorating with L- and D-TA (FIGS. 2I-J, 7A-7C).

The multiplicity of the NP surface states with different bonding strength and mode of chiral ligands to the NP core gives rise to different new chiroptical peaks, corresponding to various transitions of ligands related surface states.

In Examples 2-4 described above, three kinds of chiral thin films (electroactive V₂O₃ composite chiroptical films) were fabricated with optional electrically conductive particles by using LBL assembly method. The advantage of LBL, over, for instance spin coating, dip coating, or bar-coating is that it results in high and uniform loading of inorganic phase in the composite layer which is difficult or impossible to achieve by other methods. Additionally, layered methods enables higher charge transport due to the ability of the NPs to self-assemble as the films are being made promoting formation of percolating charge transport networks. Next, LBL affords seamless integration of different components into the composite films to achieve desirable combination of properties. Note also that unlike other applications, like batteries that may use vanadium oxide composites, chiroptically active films prepared in accordance with the present disclosure have high transparency and low scattering. Such properties are much easier to achieve with LBL due to prevention of agglomeration of NP in each layer. Last but not the least, mechanical properties are also important for electroactive thin films. LBL-engineered coatings indicate that they display required strength, toughness, and adhesion to undergo long-term cycling.

As described above, the V₂O₃-based chiroptical film were prepared by alternately exposing the ITO-coated glass to positively poly(diallyldimethylammonium chloride), PDDA, and negatively charged poly(acrylic acid), PAA, charged polymers combined with V₂O₃ NPs. Three types of multilayers were prepared: The films were prepared by dipping alternatively an ITO-glass substrate in 0.5% w/v PDDA and 1% w/v PAA/V₂O₃(Example 2), PAA/V₂O₃/CNT (Example 3) or PAA/V₂O₃/Ag NWs (Example 4) solutions.

Highly conductive additives, such as CNTs or Ag NWs, can improve the performance and long-term cycling of films with active materials. In these examples, the chiral V₂O₃-nanocomposite transparent conductive films have better conductivity by merging CNTs and Ag NWs into V₂O₃ NPs generating highly conductive networks. The Ag NWs with a length of 15 micrometers to 40 micrometers and a diameter of approximately 100 nanometers were synthesized as a component of the composite films to increase the conductivity. Their UV absorption peaks were at 351 nanometers and 382 nanometers and therefore did not interfere with the visible and NIR absorption properties of V₂O₃ NPs.

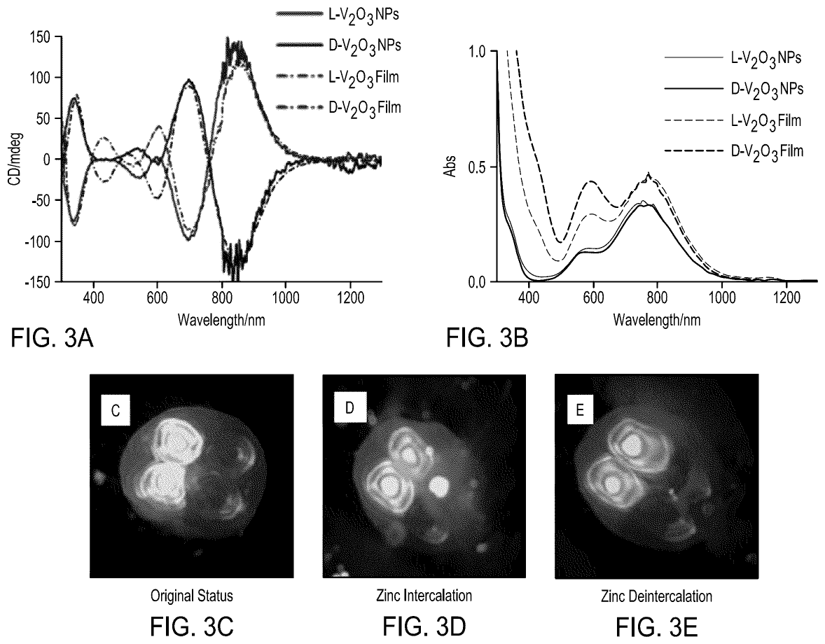

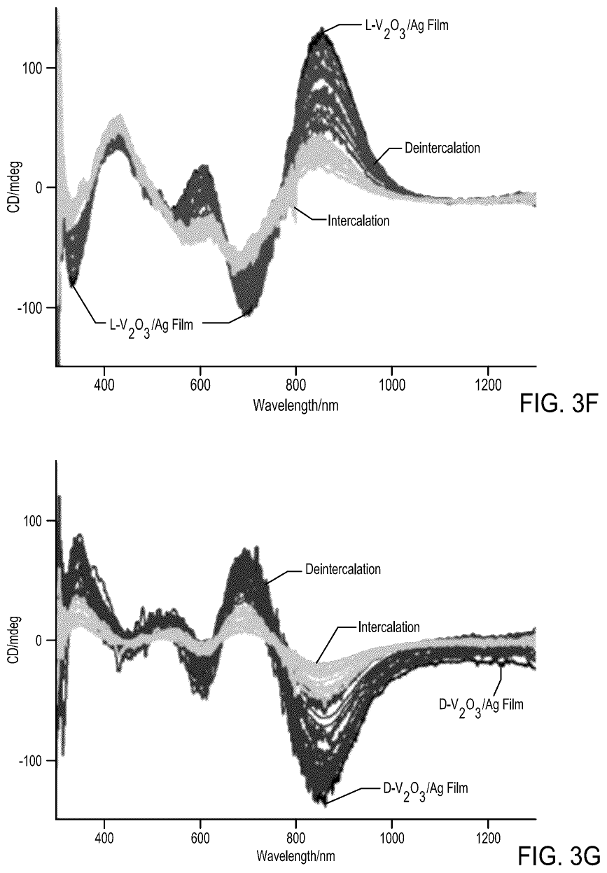

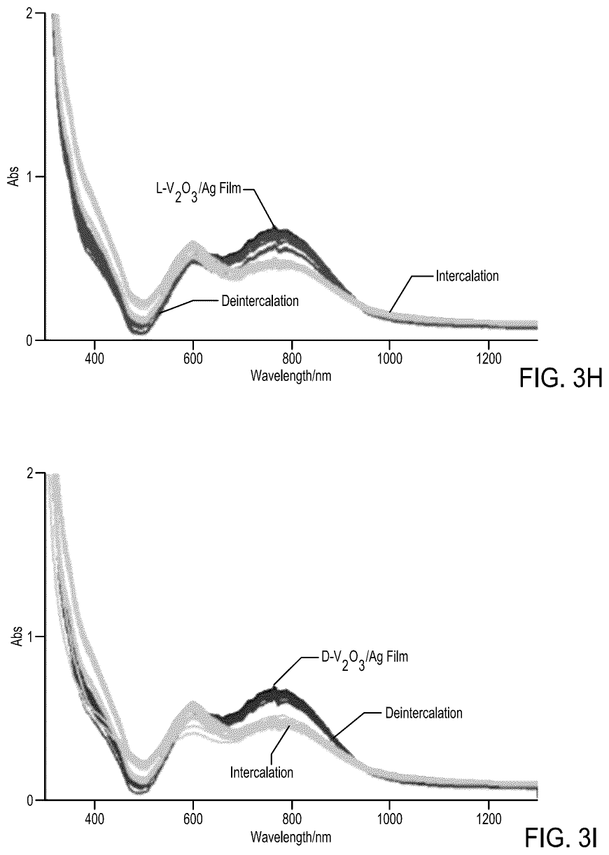

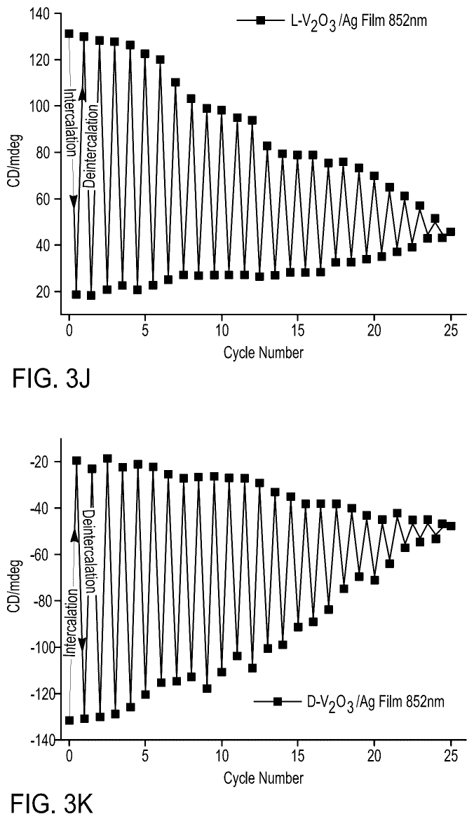

L-V₂O₃ film is transparent. The steady increase in absorbance with the number of layers along with the light green film turned into dark green (similar to the green observed for L- and D-NPs solution) was confirmed using UV-Vis spectroscopy. The cycle process is stopped when the extinction of the film reached approximately 0.5 D corresponding 120-130 mdeg in CD (the L-film). The L-films have a similar absorption spectra shape with their solutions, except the enhanced absorption at approximately 600 nanometers and a red-shift from 380 nanometers to 420 nanometers, which corresponds to the discrepancy in CD signal, i.e., the appearance of two positive peaks approximately 600 nanometers and approximately 420 nanometers, which are due to the different absorption coefficients (FIG. 3A, 3B). Chemical analysis of the L-TA-films was carried out by XPS and XRD, which is similar as the L-NPs.

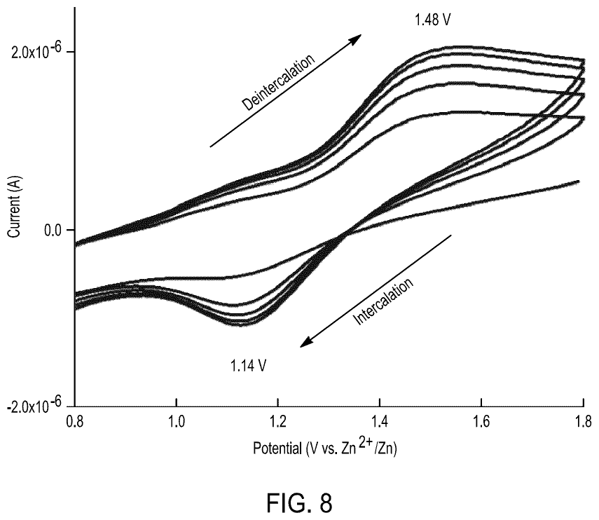

Whether voltage-driven intercalation of ions into V₂O₃ can produce noticeable changes in the CD spectra is tested. The diameter of zinc ion is 0.148 nanometers and the lattice spacing of V₂O₃ NPs is 0.1 approximately 0.37 nanometers, the primary lattice distance is 0.2 nanometers corresponding to the crystalline plane (420). The rows of vacancy sites between V—O monoclinic could accommodate the intercalation of Zn²⁺ ions. The cyclic voltammetry (CV) curve was used to characterize the intercalation of Zn²⁺ into the L-NPs film with a two-electrode configuration, as depicted in FIG. 8. There is one pair of redox reversible peaks approximately 1.14/1.48, indicating a reaction associated with Zn²⁺ insertion and extraction through the V₂O₃ ITO electrode. There is no noticeable change of peak integrated areas for both cathodic and anodic peaks after the first 5 cycles, suggesting the sufficient electrochemical reversibility of the V₂O₃ film. Based on the result of CV, the extra applied voltages were maintained at 1 and 1.8 V for zinc ions intercalation and deintercalation, respectively.

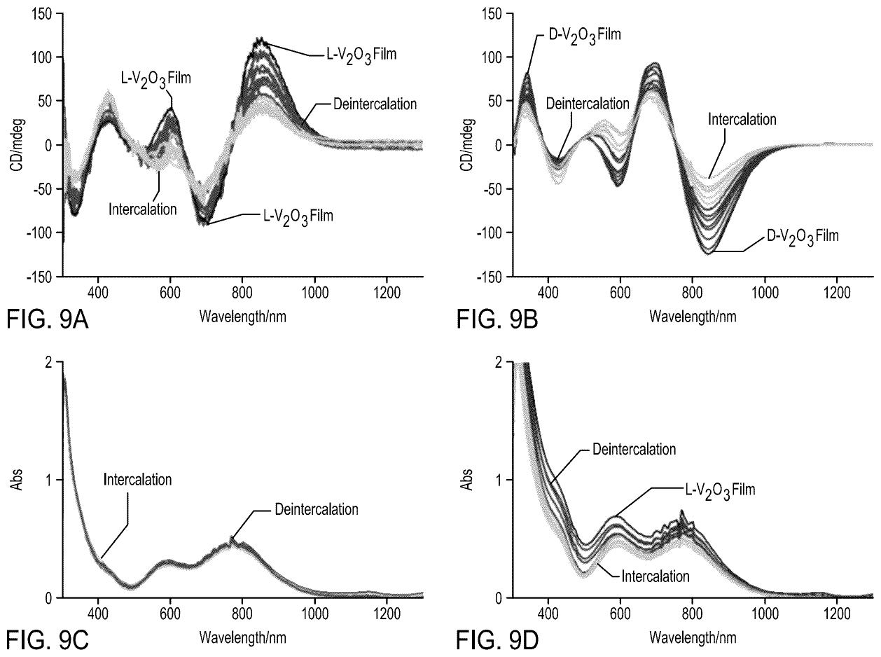

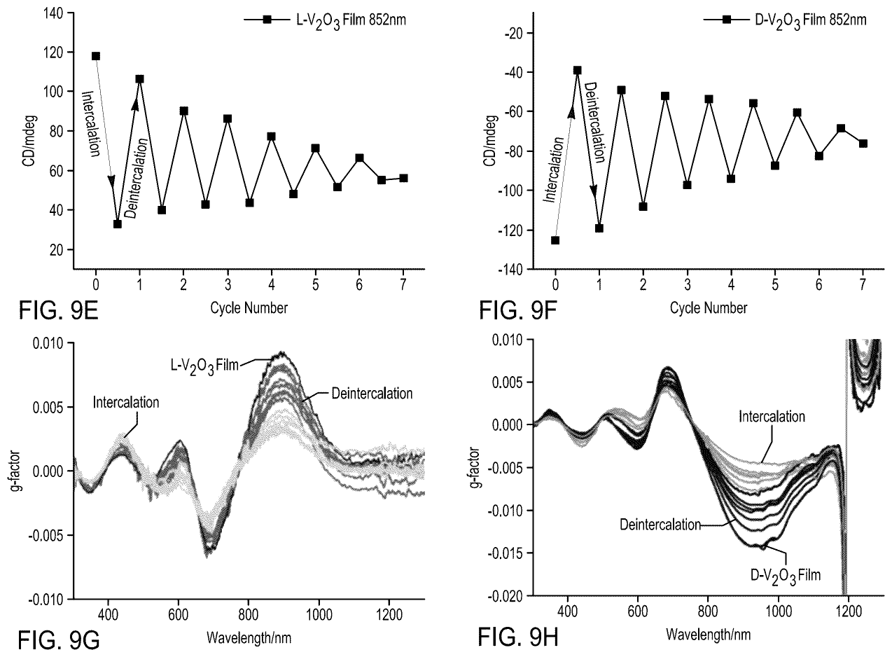

Cyclic variation of chiroptical activity of V₂O₃, V₂O₃/CNT and V₂O₃/Ag NWs thin films prepared in accordance with certain aspects of the present disclosure are explored herein. To monitor the CD signal of chiral film, the in-situ CD test with extra applied voltage was set up as shown in FIG. 4. By changing the direction of current, the Zn²⁺ ions can reversibly insert and extract from film, corresponding with exhibiting reversible CD. The shape of CD spectra does not change and the intensity of five peaks (except for peak in approximately 428 nanometers) significantly decreases after Zn²⁺ ions intercalate into L- or D-V₂O₃ film (green line, FIGS. 9A-9B). Followed by de-intercalation of Zn²⁺, ions from V₂O₃, the CD peaks at 850/697/605/340 nanometers almost recovers to its original intensity, indicating that most of Zn²⁺ ions are extracted from the NPs lattice. The cycling of zinc ions intercalation and deintercalation of the L- and D-V₂O₃ films lead to a periodic increase and decrease CD intensity and the corresponding to cyclic alternation of colors observed through cross-polarizers (FIGS. 3C-3E). Reversible switching over several CD cycles between the two states was associated with different degree of distortions of NPs crystal lattice, significantly affecting the optical and chiroptical activity in whole UV-Vis-NIR region. The corresponding absorption and g-factor are shown in FIGS. 9G-9H. The recoverability of the film gradually reduces with reaction cycle, resulting in a poor CD signal compared to the initial state. This process can be repeated 7 times, as shown in FIGS. 9E-9F. It is hard to implement more reversible cycles due to the low conductivity of NPs film. After the process of zinc intercalation, the original L/D-NPs with strong lattice distortion become weaker due to the lattice expanding, leading to a decreased CD intensity with intercalation time.

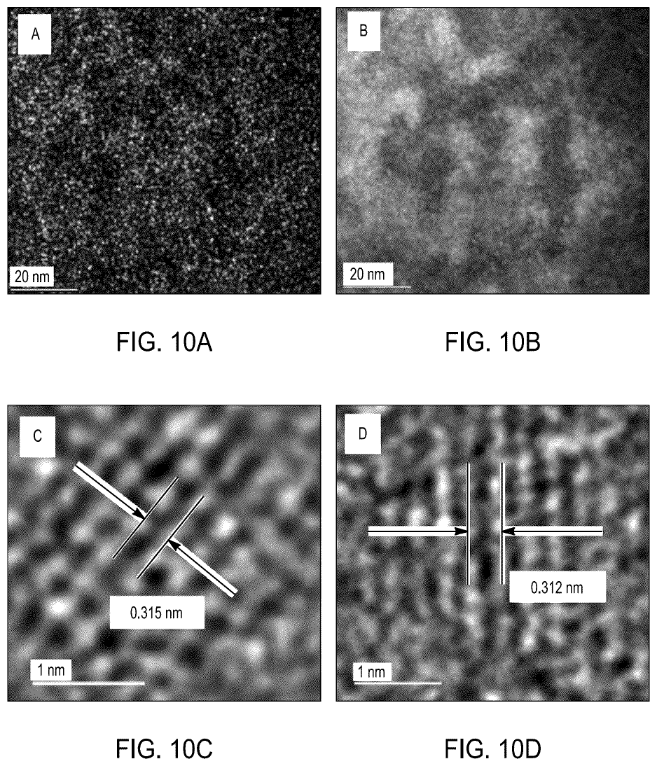

To explore the effect of Zn ion intercalation on crystal structure, V₂O₃ NPs were intentionally doped with Zn ions by mixing NPs into Zn ion solution. The V₂O₃ NPs (pH=3) were mixed into 2 M ZnSO₄ solution with one hour with magnetic stirring. The successful incorporation of Zn ions is demonstrated by the clear Zn signal recorded in EDS mapping, as shown in FIGS. 10A-10D. HRTEM images show that the lattice plane spacing of V₂O₃ NPs increased to approximately 0.3 nanometer (counting an amount of NPs) after Zn ion doping (FIGS. 10C-10D compared with FIG. 1D). The poor CD intensity for V₂O₃ NPs with weak lattice distortion restore to its original chiroptical intensity after zinc ions are extracted from the V₂O₃ lattice due to the strong lattice distortion recovered.

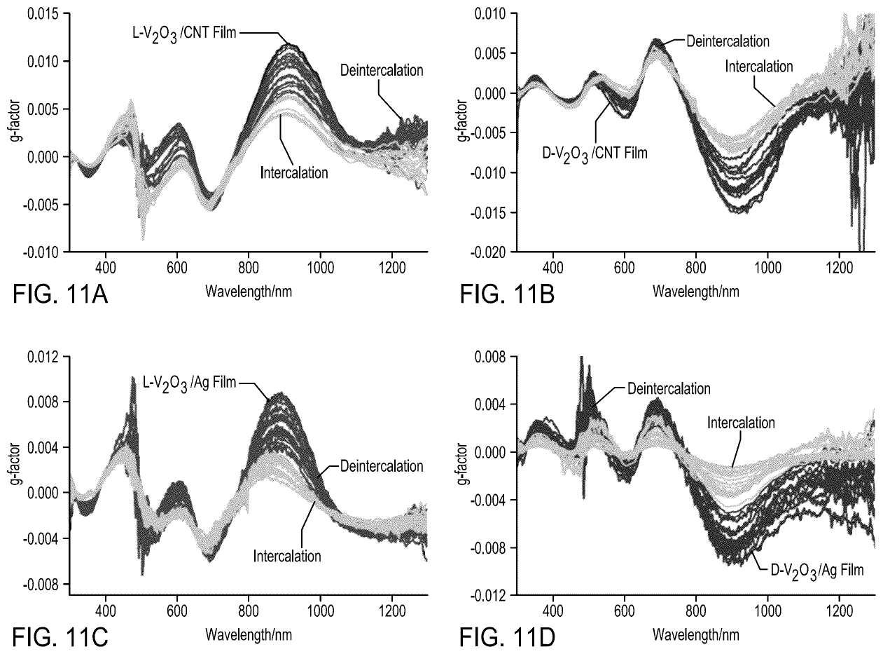

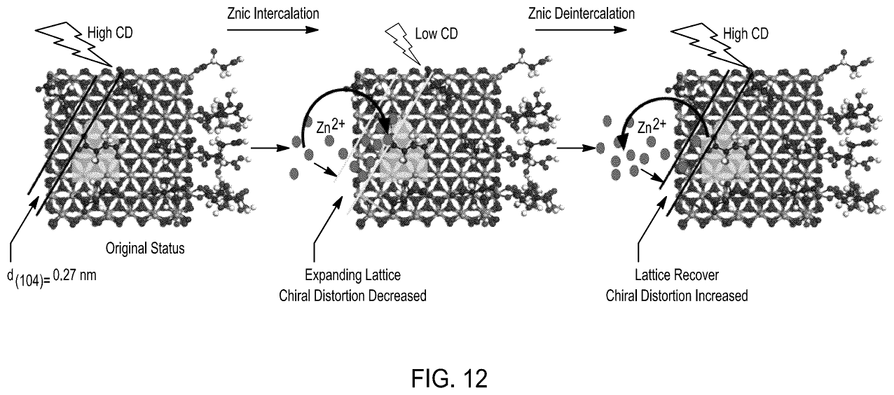

The chiral V₂O₃/CNT and V₂O₃/Ag NWs films with more CD reversible cycles were operated under the same conditions. FIG. S17 shows the 17 cycles of ion de/intercalation of V₂O₃/CNT film due to the increased conductivity of chiral film. After 17 cycles, the color of the film changes from dark green to greyish green (FIG. S18). SEM images show an obvious difference in film cross-section with roughness surface after interacting zinc ions (FIG. S19). The cycles of V₂O₃/Ag NWs film can reach up to 25 and the CD change degree is larger than V₂O₃ and V₂O₃/CNT film due to increased conductivity of film, shown in FIGS. 3F-3K. The higher conductive film exhibits a lower CD intensity after a stronger intercalation process due to more zinc ions being inserted into the NPs lattices. The corresponding g-factor of V₂O₃/CNT and V₂O₃/Ag NWs films are presented in FIGS. 11A-11D. After the charging process of the first five cycles of V₂O₃/Ag NWs film, the peak in 852 nanometers nearly recover to their initial intensity, demonstrating that the change of V₂O₃ lattice distortion upon the charge/discharge process is highly reversible with a good cycling stability. Reversible CD cycles induced by Zn²⁺ storage upon electrochemical charge and discharge processes as shown in FIG. 12. Initially, the intercalatable lattice structure of the chiral nanoparticle circular dichroism (CD). When a voltage is applied, zinc intercalates into the lattice structure, so that the lattice expands and chiral distortion decreases, leading to lower CD. Finally, when the voltage is removed, the zinc ions deintercalate from the lattice structure, so that the lattice recovers and chiral distortion is again increased to result in high CD again.

To ensure the maximum de/intercalation, the reaction process was finished until CD signal no longer changes. With the increase of the number of de/intercalation cycles, the effect of Zn²⁺ ions on CD intensity weakens gradually, indicating a small reversal and change of crystal distortion. The change degree of CD intensity and cyclic stability of V₂O₃ film not only depends on chiral lattice distortion, the side-reaction of electrochemistry could also play a part.

In all, data obtained in the examples indicate that nanoceramic films with structural chirality and conductivity can be real-time reversible modulated by electric field, showing the ability to form part of an optical component in opto-electronic devices.

More specifically, conductive films from chiral V₂O₃ NPs-based films have been demonstrated. The chiroptical activity of film can be reversibly and cyclically modulated through ion intercalation and deintercalation by applying extra voltage, corresponding to a reversible change of lattice distortion of V₂O₃ NPs. In addition, the cycle number was significantly improved by adding carbon nanotubes (CNTs) or Ag nanowires (NWs) in the chiral V₂O₃ films, due to the enhanced conductivity.

In conclusion, the present disclosure contemplates chiral vanadium oxide nanoparticles having tunable absorption properties that may be prepared via one-pot synthesis in aqueous solution, in which the L- and D-tartaric acid (TA) serve as both reducing agent and surface ligands. The NPs possess an ultrastrong chiroptical activity across a wide spectral range of UV-Visible-NIR due to the distortion of crystal lattices. The chirality of UD-NP atomic structure is confirmed by atomistic molecular dynamics simulations, showing a severe opposite lattice distortion in the inorganic core. In addition, LBL assembly methods are used to construct conductive and transparent films with chiroptical activity, which were developed on an ITO glass side using finely dispersed chiral V₂O₃ NPs, V₂O₃/CNT and V₂O₃/Ag NWs solutions. The high and low CD intensity of films can be reversibly modulated by dipping the films in ZnSO₄ electrolyte through an intercalation and deintercalation process by applying an extra voltage of 1 V and 1.8 V, respectively. The cycle of V₂O₃/Ag NWs film can be 25 times and its CD change degree is larger than the V₂O₃ film due to the increased conductivity of film. Realization of polarization modulated films by electric fields will be beneficial for the chiral ceramics in opto-electronic devices. It is envisioned that many metal oxides with excellent optical, electrical, and magnetic properties can be readily incorporated into chiral films to afford multi-functional devices.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A nanoparticle exhibiting reversible chiroptical activity, the nanoparticle comprising:
an electrically conductive metal oxide having an intercalatable lattice structure and comprising a metal selected from the group consisting of: vanadium (V), cobalt (Co), iron (Fe), manganese (Mn), and combinations thereof; and
at least one organic chiral ligand attached to a surface of the electrically conductive metal oxide, wherein the nanoparticle exhibits a first chiroptical state having a first chirality when an ion is intercalated into the intercalatable lattice structure of the electrically conductive metal oxide, the nanoparticle exhibits a distinct second chiroptical state when the ion is absent from the intercalatable lattice structure, and the nanoparticle is configured to have modulated chiroptical activity when an electric force field is applied.

2. The nanoparticle of claim 1, wherein the electrically conductive metal oxide is selected from the group consisting of: vanadium (III) oxide (V₂O₃), cobalt (II, Ill) oxide (Co₃O₄), iron (III) oxide (Fe₂O₃), manganese dioxide (MnO₂), and combinations thereof.

3. The nanoparticle of claim 1, wherein the at least one organic chiral ligand comprises at least one carboxylic group.

4. The nanoparticle of claim 3, wherein the at least one organic chiral ligand is selected from the group consisting of: tartaric acid, malic acid, penicillamine, and combinations thereof.

5. The nanoparticle of claim 1, wherein the nanoparticle has an average diameter of greater than or equal to about 0.5 nanometers to less than or equal to about 25 nanometers.

6. The nanoparticle of claim 1, wherein the nanoparticle has an average diameter of greater than or equal to about 1 nanometer to less than or equal to about 5 nanometers.

7. The nanoparticle of claim 1, wherein the ion is a zinc ion (Zn²⁺).

8. The nanoparticle of claim 1, wherein the electrically conductive metal oxide comprises vanadium (III) oxide (V₂O₃), the at least one organic chiral ligand comprises tartaric acid, and the ion is a zinc ion (Zn²⁺).

9. A nanocomposite comprising:
at least one polymer; and
a plurality of nanoparticles exhibiting reversible chiroptical activity, each respective nanoparticle comprising:
an electrically conductive metal oxide having an intercalatable lattice structure and comprising a metal selected from the group consisting of: vanadium (V), cobalt (Co), iron (Fe), manganese (Mn), and combinations thereof; and
at least one organic chiral ligand attached to a surface of the electrically conductive metal oxide, wherein each nanoparticle exhibits a first chiroptical state having a first chirality when an ion is intercalated into the intercalatable lattice structure of the electrically conductive metal oxide, each nanoparticle of the plurality exhibits a distinct second chiroptical state when the ion is absent from the intercalatable lattice structure, and the plurality of nanoparticles are configured to have modulated chiroptical activity when an electric force field is applied.

10. The nanocomposite of claim 9, wherein the at least one polymer is selected from the group consisting of: poly(dimethyldiallylammonium chloride) (PDDA), poly(acrylic acid) (PAA), polyvinyl alcohol (PVA), and combinations thereof.

11. The nanocomposite of claim 9, wherein the nanocomposite further comprises an electrically conductive particle selected from the group consisting of: carbon nanotubes, metal nanowires, graphene oxide, graphene, and combinations thereof.

12. (canceled)

13. The nanocomposite of claim 9, wherein the electrically conductive metal oxide is selected from the group consisting of: vanadium (III) oxide (V₂O₃), cobalt (II, Ill) oxide (Co₃O₄), iron (III) oxide (Fe₂O₃), manganese dioxide (MnO₂), and combinations thereof.

14. The nanocomposite of claim 9, wherein the nanocomposite defines a multilayered structure, wherein a first layer comprises poly(dimethyldiallylammonium chloride) (PDDA) and a second layer comprises poly(acrylic acid) (PAA) and the plurality of nanoparticles.

15. The nanocomposite of claim 14, wherein the second layer further comprises an electrically conductive particle.

16. The nanocomposite of claim 9, wherein the at least one organic chiral ligand is selected from the group consisting of: tartaric acid, malic acid, penicillamine, and combinations thereof.

17. The nanocomposite of claim 9, wherein the plurality of nanoparticles has an average diameter of greater than or equal to about 1 nanometers to less than or equal to about 5 nanometers.

18. The nanocomposite of claim 9, wherein the nanocomposite exhibits an electrical conductivity of greater than or equal to about 1.5×10³ S/cm.

19. The nanocomposite of claim 9, wherein the nanocomposite defines a plurality of pores and further comprises at least one electrolyte comprising a zinc salt disposed in at least a portion of the plurality of pores.

20. A device comprising:
an optic component comprising:
a plurality of nanoparticles exhibiting reversible chiroptical activity that is configured to be modulated by an electric force field, each respective nanoparticle comprising:
an electrically conductive metal oxide having an intercalatable lattice structure and comprising a metal selected from the group consisting of: vanadium (V), cobalt (Co), iron (Fe), manganese (Mn), and combinations thereof; and
at least one organic chiral ligand attached to a surface of the electrically conductive metal oxide, wherein each nanoparticle exhibits a first chiroptical state having a first chirality when an ion is intercalated into the intercalatable lattice structure of the electrically conductive metal oxide, each nanoparticle exhibits a distinct second chiroptical state when the ion is absent from the intercalatable lattice structure; and
an electric component for selectively generating the electric force field directed towards the optic component to drive the ion into the intercalatable lattice structure of the electrically conductive metal oxide of the plurality of nanoparticles, where the electric force field is configured to modulate chirality of an output of electromagnetic waves from the optic component.

21. The device of claim 20, wherein the device further comprises a source of light that directs electromagnetic waves towards the optic component.

22. The device of claim 20, wherein the optic component is a nanocomposite comprising the plurality of nanoparticles and further comprising at least one polymer.

23-30. (canceled)
